(19) United States
(12) Patent Application Publication
(10) Pub. No.: US 2026/0095356 A1
(43) Pub. Date: Apr. 2, 2026

(54) SHARED CHANNEL PREPARATION TIME FOR MULTI-CELL SCHEDULING WITH DIFFERENT SUBCARRIER SPACINGS FOR SCHEDULED CELLS

(71) Applicant: QUALCOMM Incorporated, San Diego, CA (US)

(72) Inventors: Kazuki TAKEDA, Minato-ku (JP); Kianoush HOSSEINI, San Diego, CA (US)

(21) Appl. No.: 19/344,318

(22) Filed: Sep. 29, 2025

Related U.S. Application Data
(60) Provisional application No. 63/701,900, filed on Oct. 1, 2024.

(51) Int. Cl. H04L 27/26; H04L 5/00

(52) U.S. Cl. CPC H04L 27/26025; H04L 5/0044

(57) ABSTRACT

Methods, systems, and devices for wireless communications are described. Wireless communications systems may implement cross-cell scheduling in which a downlink control information (DCI) message received by a user equipment (UE) on a scheduling cell may schedule shared channel communications on one or more different cells having different subcarrier spacings (SCSs). Rules may be defined or signaled for determination of a time gap after the DCI where the UE does not expect the DCI to schedule shared channel communications in the case where a DCI message received by the UE on a scheduling cell schedules multiple shared channel communications on multiple cells having at least two different SCSs. The time gap may be based on the SCS of the scheduling cell and the set of SCSs of the scheduled cells.

### CROSS REFERENCES

The present application for patent claims the benefit of U.S. Provisional Patent Application No. 63/701,900 by TAKEDA et al., entitled “SHARED CHANNEL PREPARATION TIME FOR MULTI-CELL SCHEDULING WITH DIFFERENT SUBCARRIER SPACINGS FOR SCHEDULED CELLS” filed Oct. 1, 2024, which is assigned to the assignee hereof, and which is expressly incorporated by reference in its entirety herein.

### INTRODUCTION

The following relates to wireless communications, including shared channel preparation time for multi-cell scheduling.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, via a third cell associated with a third cell subcarrier spacing, a message that schedules a first shared channel communication via a first cell associated with a first SCS and a second shared channel communication via a second cell associated with a second SCS, where the first SCS is different than the second SCS, participating in the first shared channel communication via the first cell at least a time gap after reception of the message, where the time gap is based on the third cell SCS, the first SCS, and the second SCS, and participating in the second shared channel communication via the second cell at least the time gap after reception of the message.

An apparatus for wireless communication at a UE is described. The apparatus may include one or more memories and one or more processors coupled with the one or more memories and configured to cause the UE to: receive, via a third cell associated with a third cell subcarrier spacing, a message that schedules a first shared channel communication via a first cell associated with a first SCS and a second shared channel communication via a second cell associated with a second SCS, where the first SCS is different than the second SCS, participate in the first shared channel communication via the first cell at least a time gap after reception of the message, where the time gap is based on the third cell SCS, the first SCS, and the second SCS, and participate in the second shared channel communication via the second cell at least the time gap after reception of the message.

Another UE for wireless communications is described. The UE may include means for receiving, via a third cell associated with a third cell subcarrier spacing, a message that schedules a first shared channel communication via a first cell associated with a first SCS and a second shared channel communication via a second cell associated with a second SCS, where the first SCS is different than the second SCS, means for participating in the first shared channel communication via the first cell at least a time gap after reception of the message, where the time gap is based on the third cell SCS, the first SCS, and the second SCS, and means for participating in the second shared channel communication via the second cell at least the time gap after reception of the message.

A non-transitory computer-readable medium storing code for wireless communications is described. The code may include instructions executable by one or more processors to receive, via a third cell associated with a third cell subcarrier spacing, a message that schedules a first shared channel communication via a first cell associated with a first SCS and a second shared channel communication via a second cell associated with a second SCS, where the first SCS is different than the second SCS, participate in the first shared channel communication via the first cell at least a time gap after reception of the message, where the time gap is based on the third cell SCS, the first SCS, and the second SCS, and participate in the second shared channel communication via the second cell at least the time gap after reception of the message.

In some examples of the method, UEs, and non-transitory computer-readable medium described herein, the time gap may be based on a highest SCS from among a set of SCSs associated with a set of cells scheduled by the message, the set of cells includes the first cell and the second cell, and the set of SCSs includes the first SCS and the second SCS.

In some examples of the method, UEs, and non-transitory computer-readable medium described herein, the time gap may be based on a lowest SCS from among a set of SCSs associated with a set of cells scheduled by the message, the set of cells includes the first cell and the second cell, and the set of SCSs includes the first SCS and the second SCS.

In some examples of the method, UEs, and non-transitory computer-readable medium described herein, the time gap may be a largest time gap from a set of candidate time gaps, the set of candidate time gaps may be based on respective comparisons between the third cell SCS and a set of SCSs associated with a set of cells scheduled by the message, the set of cells includes the first cell and the second cell, and the set of SCSs includes the first SCS and the second SCS.

Some examples of the method, UEs, and non-transitory computer-readable medium described herein may further include operations, features, means, or instructions for receiving control signaling that indicates a set of cells schedulable by DCI in a search space monitored on the third cell, where the set of cells includes the first cell and the second cell, where the time gap may be based on a highest SCS from among a set of SCSs associated with the set of cells, and where the set of SCSs includes the first SCS and the second SCS.

Some examples of the method, UEs, and non-transitory computer-readable medium described herein may further include operations, features, means, or instructions for receiving control signaling that indicates a set of cells schedulable by DCI in a search space monitored on the third cell, where the set of cells includes the first cell and the second cell, where the time gap may be based on a lowest SCS from among a set of SCSs associated with the set of cells, and where the set of SCSs includes the first SCS and the second SCS.

Some examples of the method, UEs, and non-transitory computer-readable medium described herein may further include operations, features, means, or instructions for receiving control signaling that indicates a set of cells schedulable by DCI in a search space monitored on the third cell, where the set of cells includes the first cell and the second cell, where the time gap may be a largest time gap from a set of candidate time gaps, where the set of candidate time gaps may be based on respective comparisons between the third cell SCS and a set of SCSs associated with the set of cells, and where the set of SCSs includes the first SCS and the second SCS.

Some examples of the method, UEs, and non-transitory computer-readable medium described herein may further include operations, features, means, or instructions for participating in a third shared channel communication via a third cell associated with a third SCS at least the time gap after reception of the message, where the message schedules the third shared channel communication via the third cell, where the time gap may be based on the third SCS.

In some examples of the method, UEs, and non-transitory computer-readable medium described herein, at least one of the first SCS or the second SCS may be a same as the third cell SCS.

Some examples of the method, UEs, and non-transitory computer-readable medium described herein may further include operations, features, means, or instructions for receiving control signaling that indicates a set of cells schedulable by DCI in a search space monitored on the third cell, where the set of cells includes the first cell and the second cell, refraining from monitoring for respective downlink shared channel transmissions via the set of cells during the time gap, and monitoring for the respective downlink shared channel transmissions via the set of cells after the time gap, where participation in the first shared channel communication or the second shared channel communication may be based at least on the monitoring.

A method for wireless communications by a network entity is described. The method may include outputting, via a third cell associated with a third cell subcarrier spacing, a message that schedules a first shared channel communication via a first cell associated with a first SCS and a second shared channel communication via a second cell associated with a second SCS, where the first SCS is different than the second SCS, participating in the first shared channel communication via the first cell at least a time gap after output of the message where the time gap is based on the third cell SCS, the first SCS, and the second SCS, and participating in the second shared channel communication via the second cell at least the time gap after output of the message.

An apparatus for wireless communication at a network entity is described. The apparatus may include one or more memories and one or more processors coupled with the one or more memories and configured to cause the network entity to: output, via a third cell associated with a third cell subcarrier spacing, a message that schedules a first shared channel communication via a first cell associated with a first SCS and a second shared channel communication via a second cell associated with a second SCS, where the first SCS is different than the second SCS, participate in the first shared channel communication via the first cell at least a time gap after output of the message where the time gap is based on the third cell SCS, the first SCS, and the second SCS, and participate in the second shared channel communication via the second cell at least the time gap after output of the message.

Another network entity for wireless communications is described. The network entity may include means for outputting, via a third cell associated with a third cell subcarrier spacing, a message that schedules a first shared channel communication via a first cell associated with a first SCS and a second shared channel communication via a second cell associated with a second SCS, and the first SCS is different than the second SCS, means for participating in the first shared channel communication via the first cell at least a time gap after output of the message where the time gap is based on the third cell SCS, the first SCS, and the second SCS, and means for participating in the second shared channel communication via the second cell at least the time gap after output of the message.

A non-transitory computer-readable medium storing code for wireless communications is described. The code may include instructions executable by one or more processors to output, via a third cell associated with a third cell subcarrier spacing, a message that schedules a first shared channel communication via a first cell associated with a first SCS and a second shared channel communication via a second cell associated with a second SCS, where the first SCS is different than the second SCS, participate in the first shared channel communication via the first cell at least a time gap after output of the message where the time gap is based on the third cell SCS, the first SCS, and the second SCS, and participate in the second shared channel communication via the second cell at least the time gap after output of the message.

In some examples of the method, network entities, and non-transitory computer-readable medium described herein, the time gap may be based on a highest SCS from among a set of SCSs associated with a set of cells scheduled by the message, the set of cells includes the first cell and the second cell, and the set of SCSs includes the first SCS and the second SCS.

In some examples of the method, network entities, and non-transitory computer-readable medium described herein, the time gap may be based on a lowest SCS from among a set of SCSs associated with a set of cells scheduled by the message, the set of cells includes the first cell and the second cell, and the set of SCSs includes the first SCS and the second SCS.

In some examples of the method, network entities, and non-transitory computer-readable medium described herein, the time gap may be a largest time gap from a set of candidate time gaps, the set of candidate time gaps may be based on respective comparisons between the third cell SCS and a set of SCSs associated with a set of cells scheduled by the message, the set of cells includes the first cell and the second cell, and the set of SCSs includes the first SCS and the second SCS.

Some examples of the method, network entities, and non-transitory computer-readable medium described herein may further include operations, features, means, or instructions for outputting control signaling that indicates a set of cells schedulable by DCI in a search space configured for the third cell, where the set of cells includes the first cell and the second cell, where the time gap may be based on a highest SCS from among a set of SCSs associated with the set of cells, and where the set of SCSs includes the first SCS and the second SCS.

Some examples of the method, network entities, and non-transitory computer-readable medium described herein may further include operations, features, means, or instructions for outputting control signaling that indicates a set of cells schedulable by DCI in a search space configured for the third cell, where the set of cells includes the first cell and the second cell, where the time gap may be based on a lowest SCS from among a set of SCSs associated with the set of cells, and where the set of SCSs includes the first SCS and the second SCS.

Some examples of the method, network entities, and non-transitory computer-readable medium described herein may further include operations, features, means, or instructions for outputting control signaling that indicates a set of cells schedulable by DCI in a search space configured for the third cell, where the set of cells includes the first cell and the second cell, where the time gap may be a largest time gap from a set of candidate time gaps, where the set of candidate time gaps may be based on respective comparisons between the third cell SCS and a set of SCSs associated with the set of cells, and where the set of SCSs includes the first SCS and the second SCS.

Some examples of the method, network entities, and non-transitory computer-readable medium described herein may further include operations, features, means, or instructions for participating in a third shared channel communication via a third cell associated with a third SCS at least the time gap after output of the message, where the message schedules the third shared channel communication via the third cell, where the time gap may be based on the third SCS.

In some examples of the method, network entities, and non-transitory computer-readable medium described herein, at least one of the first SCS or the second SCS may be a same as the third cell SCS.

A method for wireless communications by a user equipment (UE) is described. The method may include receiving a downlink control information (DCI) message via a scheduling cell associated with a scheduling cell subcarrier spacing (SCS), where the DCI message schedules a first shared channel communication via a first cell associated with a first SCS, where the DCI message schedules a second shared channel communication via a second cell associated with a second SCS, and where the first SCS is different than the second SCS, participating in the first shared channel communication via the first cell at least a time gap after reception of the DCI message, where the time gap is based on the scheduling cell SCS, the first SCS, and the second SCS, and participating in the second shared channel communication via the second cell at least the time gap after reception of the DCI message.

An apparatus for wireless communication at a UE is described. The apparatus may include one or more memories and one or more processors coupled with the one or more memories and configured to cause the UE to: receive a DCI message via a scheduling cell associated with a scheduling cell SCS, where the DCI message schedules a first shared channel communication via a first cell associated with a first SCS, where the DCI message schedules a second shared channel communication via a second cell associated with a second SCS, and where the first SCS is different than the second SCS, participate in the first shared channel communication via the first cell at least a time gap after reception of the DCI message, where the time gap is based on the scheduling cell SCS, the first SCS, and the second SCS, and participate in the second shared channel communication via the second cell at least the time gap after reception of the DCI message.

Another UE for wireless communications is described. The UE may include means for receiving a DCI message via a scheduling cell associated with a scheduling cell SCS, where the DCI message schedules a first shared channel communication via a first cell associated with a first SCS, where the DCI message schedules a second shared channel communication via a second cell associated with a second SCS, and where the first SCS is different than the second SCS, means for participating in the first shared channel communication via the first cell at least a time gap after reception of the DCI message, where the time gap is based on the scheduling cell SCS, the first SCS, and the second SCS, and means for participating in the second shared channel communication via the second cell at least the time gap after reception of the DCI message.

A non-transitory computer-readable medium storing code for wireless communications is described. The code may include instructions executable by one or more processors to receive a DCI message via a scheduling cell associated with a scheduling cell SCS, where the DCI message schedules a first shared channel communication via a first cell associated with a first SCS, where the DCI message schedules a second shared channel communication via a second cell associated with a second SCS, and where the first SCS is different than the second SCS, participate in the first shared channel communication via the first cell at least a time gap after reception of the DCI message, where the time gap is based on the scheduling cell SCS, the first SCS, and the second SCS, and participate in the second shared channel communication via the second cell at least the time gap after reception of the DCI message.

In some examples of the method, UEs, and non-transitory computer-readable medium described herein, the time gap may be based on a highest SCS from among a set of SCSs associated with a set of cells scheduled by the DCI message, the set of cells includes the first cell and the second cell, and the set of SCSs includes the first SCS and the second SCS.

In some examples of the method, UEs, and non-transitory computer-readable medium described herein, the time gap may be based on a lowest SCS from among a set of SCSs associated with a set of cells scheduled by the DCI message, the set of cells includes the first cell and the second cell, and the set of SCSs includes the first SCS and the second SCS.

In some examples of the method, UEs, and non-transitory computer-readable medium described herein, the time gap may be a largest time gap from a set of candidate time gaps, the set of candidate time gaps may be based on respective comparisons between the scheduling cell SCS and a set of SCSs associated with a set of cells scheduled by the DCI message, the set of cells includes the first cell and the second cell, and the set of SCSs includes the first SCS and the second SCS.

Some examples of the method, UEs, and non-transitory computer-readable medium described herein may further include operations, features, means, or instructions for receiving control signaling that indicates a set of cells schedulable by DCI in a search space monitored on the scheduling cell, where the set of cells includes the first cell and the second cell, where the time gap may be based on a highest SCS from among a set of SCSs associated with the set of cells, and where the set of SCSs includes the first SCS and the second SCS.

Some examples of the method, UEs, and non-transitory computer-readable medium described herein may further include operations, features, means, or instructions for receiving control signaling that indicates a set of cells schedulable by DCI in a search space monitored on the scheduling cell, where the set of cells includes the first cell and the second cell, where the time gap may be based on a lowest SCS from among a set of SCSs associated with the set of cells, and where the set of SCSs includes the first SCS and the second SCS.

Some examples of the method, UEs, and non-transitory computer-readable medium described herein may further include operations, features, means, or instructions for receiving control signaling that indicates a set of cells schedulable by DCI in a search space monitored on the scheduling cell, where the set of cells includes the first cell and the second cell, where the time gap may be a largest time gap from a set of candidate time gaps, where the set of candidate time gaps may be based on respective comparisons between the scheduling cell SCS and a set of SCSs associated with the set of cells, and where the set of SCSs includes the first SCS and the second SCS.

Some examples of the method, UEs, and non-transitory computer-readable medium described herein may further include operations, features, means, or instructions for participating in a third shared channel communication via a third cell associated with a third SCS at least the time gap after reception of the DCI message, where the DCI message schedules the third shared channel communication via the third cell, where the time gap may be based on the third SCS.

In some examples of the method, UEs, and non-transitory computer-readable medium described herein, at least one of the first SCS or the second SCS may be a same as the scheduling cell SCS.

Some examples of the method, UEs, and non-transitory computer-readable medium described herein may further include operations, features, means, or instructions for receiving control signaling that indicates a set of cells schedulable by DCI in a search space monitored on the scheduling cell, where the set of cells includes the first cell and the second cell, refraining from monitoring for respective downlink shared channel transmissions via the set of cells during the time gap, and monitoring for the respective downlink shared channel transmissions via the set of cells after the time gap, where participation in the first shared channel communication or the second shared channel communication may be based at least on the monitoring.

A method for wireless communications by a network entity is described. The method may include outputting a DCI message via a scheduling cell associated with a scheduling cell SCS, where the DCI message schedules a first shared channel communication via a first cell associated with a first SCS, and where the DCI message schedules a second shared channel communication via a second cell associated with a second SCS, and where the first SCS is different than the second SCS, participating in the first shared channel communication via the first cell at least a time gap after output of the DCI message where the time gap is based on the scheduling cell SCS, the first SCS, and the second SCS, and participating in the second shared channel communication via the second cell at least the time gap after output of the DCI message.

An apparatus for wireless communication at a network entity is described. The apparatus may include one or more memories and one or more processors coupled with the one or more memories and configured to cause the network entity to: output a DCI message via a scheduling cell associated with a scheduling cell SCS, where the DCI message schedules a first shared channel communication via a first cell associated with a first SCS, and where the DCI message schedules a second shared channel communication via a second cell associated with a second SCS, and where the first SCS is different than the second SCS, participate in the first shared channel communication via the first cell at least a time gap after output of the DCI message where the time gap is based on the scheduling cell SCS, the first SCS, and the second SCS, and participate in the second shared channel communication via the second cell at least the time gap after output of the DCI message.

Another network entity for wireless communications is described. The network entity may include means for outputting a DCI message via a scheduling cell associated with a scheduling cell SCS, where the DCI message schedules a first shared channel communication via a first cell associated with a first SCS, and where the DCI message schedules a second shared channel communication via a second cell associated with a second SCS, and where the first SCS is different than the second SCS, means for participating in the first shared channel communication via the first cell at least a time gap after output of the DCI message where the time gap is based on the scheduling cell SCS, the first SCS, and the second SCS, and means for participating in the second shared channel communication via the second cell at least the time gap after output of the DCI message.

A non-transitory computer-readable medium storing code for wireless communications is described. The code may include instructions executable by one or more processors to output a DCI message via a scheduling cell associated with a scheduling cell SCS, where the DCI message schedules a first shared channel communication via a first cell associated with a first SCS, and where the DCI message schedules a second shared channel communication via a second cell associated with a second SCS, and where the first SCS is different than the second SCS, participate in the first shared channel communication via the first cell at least a time gap after output of the DCI message where the time gap is based on the scheduling cell SCS, the first SCS, and the second SCS, and participate in the second shared channel communication via the second cell at least the time gap after output of the DCI message.

In some examples of the method, network entities, and non-transitory computer-readable medium described herein, the time gap may be based on a highest SCS from among a set of SCSs associated with a set of cells scheduled by the DCI message, the set of cells includes the first cell and the second cell, and the set of SCSs includes the first SCS and the second SCS.

In some examples of the method, network entities, and non-transitory computer-readable medium described herein, the time gap may be based on a lowest SCS from among a set of SCSs associated with a set of cells scheduled by the DCI message, the set of cells includes the first cell and the second cell, and the set of SCSs includes the first SCS and the second SCS.

In some examples of the method, network entities, and non-transitory computer-readable medium described herein, the time gap may be a largest time gap from a set of candidate time gaps, the set of candidate time gaps may be based on respective comparisons between the scheduling cell SCS and a set of SCSs associated with a set of cells scheduled by the DCI message, the set of cells includes the first cell and the second cell, and the set of SCSs includes the first SCS and the second SCS.

Some examples of the method, network entities, and non-transitory computer-readable medium described herein may further include operations, features, means, or instructions for outputting control signaling that indicates a set of cells schedulable by DCI in a search space configured for the scheduling cell, where the set of cells includes the first cell and the second cell, where the time gap may be based on a highest SCS from among a set of SCSs associated with the set of cells, and where the set of SCSs includes the first SCS and the second SCS.

Some examples of the method, network entities, and non-transitory computer-readable medium described herein may further include operations, features, means, or instructions for outputting control signaling that indicates a set of cells schedulable by DCI in a search space configured for the scheduling cell, where the set of cells includes the first cell and the second cell, where the time gap may be based on a lowest SCS from among a set of SCSs associated with the set of cells, and where the set of SCSs includes the first SCS and the second SCS.

Some examples of the method, network entities, and non-transitory computer-readable medium described herein may further include operations, features, means, or instructions for outputting control signaling that indicates a set of cells schedulable by DCI in a search space configured for the scheduling cell, where the set of cells includes the first cell and the second cell, where the time gap may be a largest time gap from a set of candidate time gaps, where the set of candidate time gaps may be based on respective comparisons between the scheduling cell SCS and a set of SCSs associated with the set of cells, and where the set of SCSs includes the first SCS and the second SCS.

Some examples of the method, network entities, and non-transitory computer-readable medium described herein may further include operations, features, means, or instructions for participating in a third shared channel communication via a third cell associated with a third SCS at least the time gap after output of the DCI message, where the DCI message schedules the third shared channel communication via the third cell, where the time gap may be based on the third SCS.

In some examples of the method, network entities, and non-transitory computer-readable medium described herein, at least one of the first SCS or the second SCS may be a same as the scheduling cell SCS.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports shared channel preparation time for multi-cell scheduling with different subcarrier spacings (SCSs) for scheduled cells in accordance with one or more aspects of the present disclosure.

FIG. 2 shows an example of a network architecture that supports shared channel preparation time for multi-cell scheduling with different SCSs for scheduled cells in accordance with one or more aspects of the present disclosure.

FIGS. 3A and 3B show examples of scheduling configurations that support shared channel preparation time for multi-cell scheduling with different SCSs for scheduled cells in accordance with one or more aspects of the present disclosure.

FIG. 4 shows an example of a wireless communications system that supports shared channel preparation time for multi-cell scheduling with different SCSs for scheduled cells in accordance with one or more aspects of the present disclosure.

FIGS. 5A and 5B show examples of scheduling configurations that support shared channel preparation time for multi-cell scheduling with different SCSs for scheduled cells in accordance with one or more aspects of the present disclosure.

FIG. 6 shows an example of a process flow that supports shared channel preparation time for multi-cell scheduling with different SCSs for scheduled cells in accordance with one or more aspects of the present disclosure.

FIGS. 7 and 8 show block diagrams of devices that support shared channel preparation time for multi-cell scheduling with different SCSs for scheduled cells in accordance with one or more aspects of the present disclosure.

FIG. 9 shows a block diagram of a communications manager that supports shared channel preparation time for multi-cell scheduling with different SCSs for scheduled cells in accordance with one or more aspects of the present disclosure.

FIG. 10 shows a diagram of a system including a device that supports shared channel preparation time for multi-cell scheduling with different SCSs for scheduled cells in accordance with one or more aspects of the present disclosure.

FIGS. 11 and 12 show block diagrams of devices that support shared channel preparation time for multi-cell scheduling with different SCSs for scheduled cells in accordance with one or more aspects of the present disclosure.

FIG. 13 shows a block diagram of a communications manager that supports shared channel preparation time for multi-cell scheduling with different SCSs for scheduled cells in accordance with one or more aspects of the present disclosure.

FIG. 14 shows a diagram of a system including a device that supports shared channel preparation time for multi-cell scheduling with different SCSs for scheduled cells in accordance with one or more aspects of the present disclosure.

FIGS. 15, 16, 17, and 18 show flowcharts illustrating methods that support shared channel preparation time for multi-cell scheduling with different SCSs for scheduled cells in accordance with one or more aspects of the present disclosure.

### DETAILED DESCRIPTION

Wireless communications systems may support multi-carrier or multi-cell operation to increase data rates and decrease latency. Some wireless communications systems may implement cross-cell or multi-cell scheduling. In cross-cell scheduling, a user equipment (UE) may receive a downlink control information (DCI) message via a “scheduling cell” that schedules communication(s) on a different “scheduled cell.” Similarly, in multi-cell scheduling, the UE may receive a DCI message via the scheduling cell that schedules communications on multiple different scheduled cells. For example, DCI formats 0_3 or 1_3 may be used to schedule up to four cells, and DCI formats 0_3 or 1_3 may schedule up to eight physical uplink shared channel (PUSCH) or physical downlink shared channel (PDSCH) transmissions.

Scheduling multiple shared channel communications via a single DCI may save power at a UE (e.g., by reducing the quantity of physical downlink control channel (PDCCH) occasions for the UE to monitor) and may reduce PDCCH overhead. When a scheduled cell has a different subcarrier spacing (SCS) than the scheduling cell, the UE may not expect the transmission scheduled by a DCI message on the scheduling cell to occur until after a time gap extending from an end of the PDCCH carrying the DCI message, where the time gap is based on the SCS of the scheduled cell. As defined herein, the time gap may be a time period after the end of the PDCCH carrying a DCI message during which the UE does not expect the DCI message to schedule a shared channel communication. The duration of the time gap may be determined based on a comparison of the SCS of the scheduling cell and the SCS of the scheduled cell. For example, if the SCS of the scheduling cell is greater than the SCS of the scheduled cell, the duration of the time gap may be a quantity of symbols determined from a lookup table (e.g., Table 1 as described herein) based on the SCS of the scheduling cell. As another example, if the SCS of the scheduling cell is less than the SCS of the scheduled cell, the time gap may extend end of the PDCCH carrying the DCI until the first symbol of the first slot at least a quantity of symbols determined from a lookup table (e.g., Table 1 as described herein) based on the SCS of the scheduling cell after the end of the PDCCH carrying the DCI. Thus, the duration of the time gap may be longer when the SCS of the scheduling cell is less than the SCS of the scheduled cell as compared to the time gap when the SCS of the scheduling cell is greater than the SCS of the scheduled cell. Further, there may be zero time gap (e.g., the time gap may be zero symbols) when the SCS of the scheduling cell is equal to the SCS of the scheduled cell. As the UE does not expect to receive a PDSCH transmission scheduled by a DCI during the time gap after reception of the DCI, the time gap may allow the UE to refrain from monitoring for and buffering PDSCH candidates on the scheduled cell(s) until after the time gap. Accordingly, the time gap map allows the UE time to decode the DCI message which indicates the specific resources for the UE to monitor for the PDSCH. Once the UE decodes the DCI message, the UE may monitor the specific scheduled resources for the PDSCH, and thus may not waste power and memory monitoring PDSCH candidates on the scheduled cell which are not actually scheduled by the DCI.

In the case where multiple scheduled cells have different SCSs, however, which SCS to use to determine the time gap may be undefined. For example, the time gap may be zero (e.g., a non-existent time gap if the SCS of the scheduling cell is equal to the SCS of at least one scheduled cell); until a quantity of symbols after the end of the PDCCH determined from a lookup table (e.g., Table 1 as described herein) based on the SCS of the scheduling cell (e.g., if the SCS of the scheduling cell is greater than the SCS of at least one scheduled cell); or until the first symbol of the first slot at least a quantity of symbols determined from a lookup table (e.g., Table 1 as described herein) based on the SCS of the scheduling cell after the end of the PDCCH carrying the DCI (e.g., e.g., if the SCS of the scheduling cell is less than the SCS of at least one scheduled cell). Accordingly, in the case where the SCS of one scheduled cell is less than the SCS of the scheduled cell and another SCS of another scheduled cell is equal to or greater than the SCS of the scheduling cell, the time gap to apply to the scheduled cells may be undefined. Similarly, in the case where the SCS of one scheduled cell is greater than the SCS of the scheduled cell and another SCS of another scheduled cell is equal to or less than the SCS of the scheduling cell, the time gap to apply to the scheduled cells may be undefined. Thus, an undefined time gap may cause the UE to monitor PDSCH candidates on the multiple scheduled cells starting at the same time as a PDCCH occasion carrying a DCI that schedules multiple cells, which may increase UE power consumption and resource overhead.

Aspects of this disclosure relate to rules for defining the time gap (e.g., the PDCCH processing time gap) in the case where a DCI message received by the UE on a scheduling cell schedules multiple shared channel communications on multiple scheduled cells having at least two different SCSs. The time gap may be based on the SCS of the scheduling cell and the set of SCSs of the scheduled cells. In some examples, the time gap may be determined based on the scheduled cells (e.g., based on the highest or lowest SCS from among the scheduled cells or based on the SCS from among the scheduled cells that results in the longest time gap). In some examples, the time gap may be determined based on the set of schedulable cells. For example, radio resource control (RRC) signaling may configure parameters for cross-cell scheduling, including which set of cells may be scheduled by the scheduling cell as well as the SCSs of the set of schedulable cells. For example, the time gap may be determined based on highest or lowest SCS from among the schedulable cells or based on the SCS from among the schedulable cells that results in the longest time gap.

By defining rules for determination of a time gap in the case where a DCI message received by the UE on a scheduling cell schedules multiple shared channel communications on multiple cells having at least two different SCSs, the UE may refrain from monitoring for PDSCH transmissions on the schedulable cells during the time gap. Refraining from monitoring for the PDSCH transmission on the schedulable cells during the time gap may save power at the UE. Further, the network may use communication resources during the time gap for communications with other UEs. Accordingly, definition of rules for determination of the time gap in the case where a DCI message received by the UE on a scheduling cell schedules multiple shared channel communications on multiple cells having at least two different SCSs may reduce UE power consumption and may allow for more efficient use of communication resources by the network.

Aspects of the disclosure are initially described in the context of wireless communications systems. Aspects of the disclosure are further illustrated by and described with reference to network architectures, scheduling configurations, process flows, apparatus diagrams, system diagrams, and flowcharts that relate to shared channel preparation time for multi-cell scheduling with different SCSs for scheduled cells.

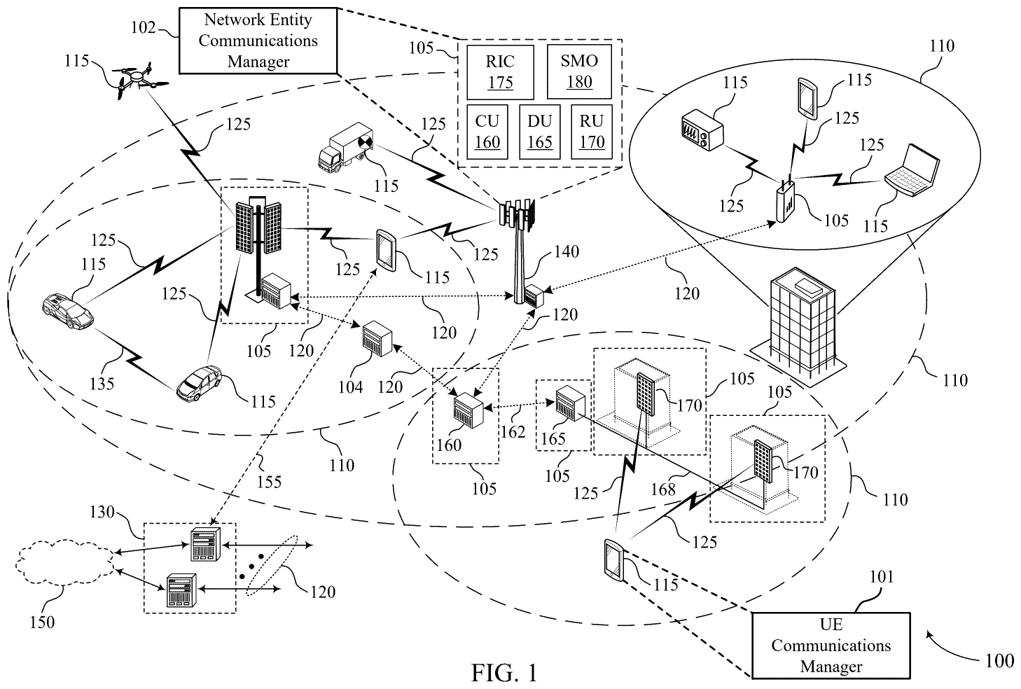

FIG. 1 shows an example of a wireless communications system 100 that supports shared channel preparation time for multi-cell scheduling with different SCSs for scheduled cells in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support shared channel preparation time for multi-cell scheduling with different SCSs for scheduled cells as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Techniques described herein, in addition to or as an alternative to be carried out between UEs 115 and base stations, may be implemented via additional or alternative wireless devices, including IAB nodes 104, DUs 165, CUs 160, RUs 170, and the like. For example, in some implementations, aspects described herein may be implemented in the context of a disaggregated RAN architecture (e.g., open RAN architecture). In a disaggregated architecture, the RAN may be split into three areas of functionality corresponding to the CU 160, the DU 165, and the RU 170. The split of functionality between the CU 160, DU 165, and RU 170 is flexible and as such gives rise to numerous permutations of different functionalities depending upon which functions (e.g., MAC functions, baseband functions, radio frequency functions, and any combinations thereof) are performed at the CU 160, DU 165, and RU 170. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more base stations may include CUs 160, DUs 165, and RUs 170 and may be referred to as donor base stations or IAB donors. One or more DUs 165 (e.g., and/or RUs 170) associated with a donor base station may be partially controlled by CUs 160 associated with the donor base station. The one or more donor base stations (e.g., IAB donors) may be in communication with one or more additional base stations (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of base stations. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, SDAP, PDCP, etc.) functionality and signaling. The at least one DU 165 and/or RU 170 may host lower layer, such as L1 and L2 (e.g., RLC, MAC, PHY, etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a base station may additionally or alternatively be performed by components of the disaggregated RAN architecture (e.g., IAB nodes, DUs, CUs, etc.).

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and SCS may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a SCS (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported SCS, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on SCS. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support multi-carrier or multi-cell operation to increase data rates and decrease latency. The wireless communications system 100 may implement cross-cell scheduling. For example, a network entity 105 may transmit, via a network entity communications manager 102, and a UE 115 may receive, via a UE communications manager 101, a DCI message via a first cell that may schedule communications on one or more different cells. For example, DCI formats 0_3 or 1_3 may be used to schedule up to four cells, and DCI formats 0_3 or 1_3 may schedule up to eight PDSCH or PUSCH transmissions. Scheduling multiple shared channel communications via a single DCI may save power at the UE 115 (e.g., by reducing the quantity of PDCCH occasions to monitor) and may reduce PDCCH overhead. The UE 115 and the network entity 105 may participate in the scheduled shared channel communications using the UE communications manager 101 and the network entity communications manager 102.

When a scheduled cell has a different SCS than the scheduling cell, the UE 115 may not expect the transmission scheduled by a DCI message on the scheduling cell to occur until after a time gap from the DCI message based on the SCS of the scheduled cell. Accordingly, the time gap may be a time period after reception of a DCI message during which the UE 115 does not expect the DCI message to schedule a shared channel communication.

The time gap may allow the UE 115 to refrain from buffering PDSCH candidates on the scheduled cell(s) until after the time gap, and accordingly until after the UE 115 decodes the DCI message which indicates the specific resources for the UE 115 to monitor for the PDSCH. In accordance with aspects of this disclosure, rules may define the time gap (e.g., the PDCCH processing time gap) in the case where a DCI message received by the UE 115 on a scheduling cell schedules multiple shared channel communications on multiple cells having at least two different SCSs. The time gap may be based on the SCS of the scheduling cell and the set of SCSs of the scheduled cells. In some examples, the time gap may be determined based on the scheduled cells (e.g., based on the highest or lowest SCS from among the scheduled cells or based on the SCS from among the scheduled cells that results in the longest time gap). In some examples, the time gap may be determined based on the set of schedulable cells. For example, RRC signaling may configure parameters for cross-cell scheduling, including which set of cells may be scheduled by the scheduling cell as well as the SCSs of the set of schedulable cells. For example, the time gap may be determined based on highest or lowest SCS from among the schedulable cells or based on the SCS from among the schedulable cells that results in the longest time gap.

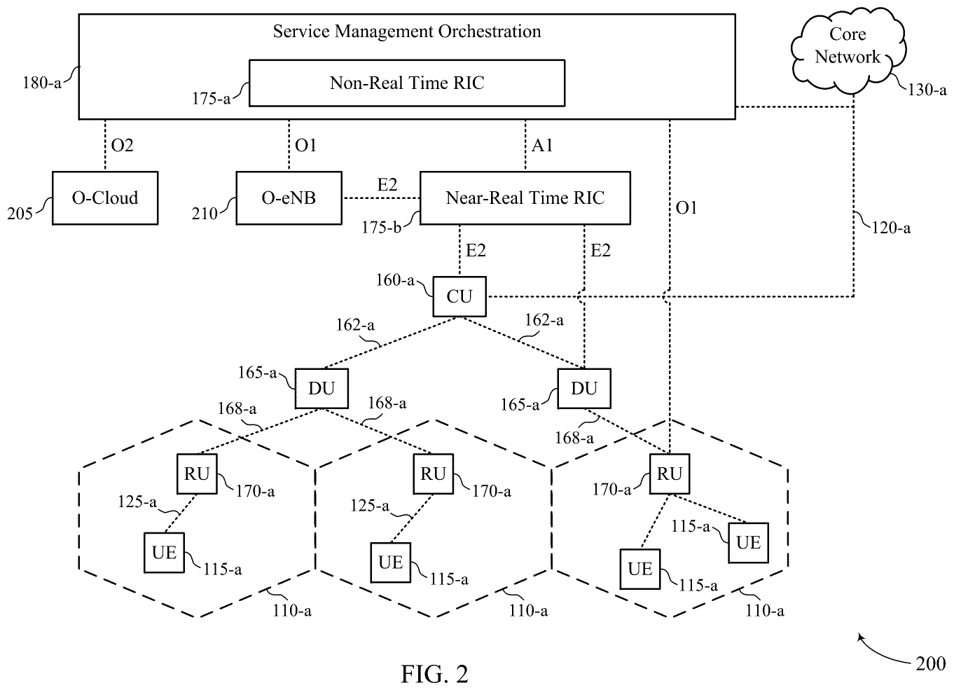

FIG. 2 shows an example of a network architecture 200 (e.g., a disaggregated base station architecture, a disaggregated RAN architecture) that supports shared channel preparation time for multi-cell scheduling with different SCSs for scheduled cells in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (IFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an AI interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., AI policies).

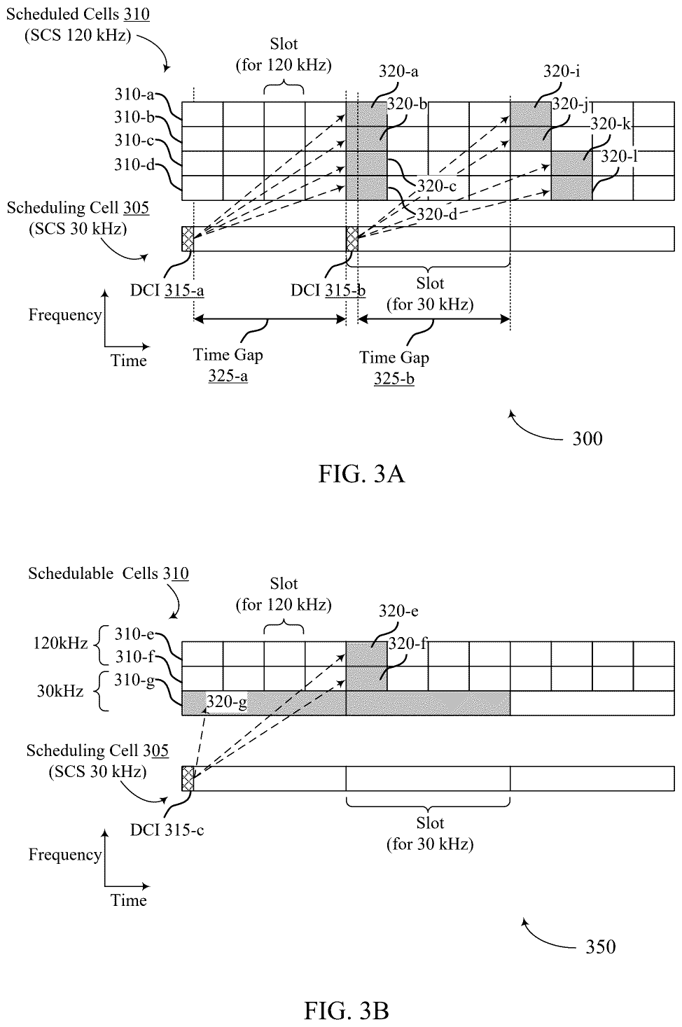

FIG. 3A shows an example of a scheduling configuration 300 that supports shared channel preparation time for multi-cell scheduling with different SCSs for scheduled cells in accordance with one or more aspects of the present disclosure. FIG. 3B shows an example of a scheduling configuration 350 that supports shared channel preparation time for multi-cell scheduling with different SCSs for scheduled cells in accordance with one or more aspects of the present disclosure. In some examples, aspects of the scheduling configuration 300 or the scheduling configuration 350 may implement, or be implemented by, aspects of the wireless communications system 100, the network architecture 200, or both.

As noted previously herein, some wireless communications systems may support multi-carrier or multi-cell operation to increase data rates and decrease latency. For example, 5G commercial networks may implement multi-cell (e.g., multi-carrier) operation by aggregating various spectrum resources in order to provide high data rate and low latency communications.

Some wireless communications systems may implement cross-cell or multi-cell scheduling. In cross-cell scheduling, a UE 115 may receive a DCI message via a “scheduling cell” that schedules communication(s) on a different “scheduled cell.” Similarly, in multi-cell scheduling, the UE may receive a DCI message via the scheduling cell that schedules communications on multiple different scheduled cells. For example, DCI formats 0_3 or 1_3 may be used to schedule up to four cells (and a single PUSCH/PDSCH may be scheduled per cell by DCI formats 0_3 or 1_3), and DCI formats 0_3 or 1_3 may schedule up to eight PUSCH or PDSCH transmissions. Some wireless networks that support communications within Frequency Range 2 (FR2) with high SCS may support multi-PDSCH/PUSCH scheduling, where a single DCI format 0_1 or 1_1 may be used to schedule up to eight PUSCHs or PDSCHs on a single serving cell in order to save UE 115 power consumption and reduce PDCCH overhead.

An example of multi-carrier scheduling is provided in the scheduling configuration 300 illustrated in FIG. 3A. As shown in FIG. 3A, a UE 115 may receive a DCI message 315-a and a DCI message 315-b via a scheduling cell 305, where the DCI messages 315 schedule communications (e.g., PUSCH, PDSCH communications) on multiple scheduled cells 310-a, 310-b, 310-c, and 310-d (e.g., multi-cell or multi-carrier scheduling). For example, the DCI message 315-a may schedule communications within slots 320-a, 320-b, 320-c, and 320-d of the respective scheduled cells 310-a, 310-b, 310-c, and 310-d. Similarly, the DCI message 315-b may schedule communications within slots 320-i, 320-j, 320-k, and 320-1 of the respective scheduled cells 310-a, 310-b, 310-c, and 310-d. In this example, the scheduling cell 305 may be associated with a first SCS (e.g., 30 kHz), and the scheduled cells 310 may be associated with a second SCS (e.g., 120 kHz). In some aspects, the DCI message 315-a and/or the DCI message 315-b may include DCI formats 0_3 or 1_3.

In cross-carrier scheduling, as shown in FIG. 3A, where the scheduling cell is associated with a different SCS than the scheduled cell or scheduled cells, the UE 115 may not expect a shared channel communication scheduled by a DCI message 315 to begin until at least a time gap 325 after the PDCCH conveying the DCI message 315. For example, the UE 115 may not monitor for PDSCH transmissions on the scheduled cells 310 during slots of the time gap 325. For example, the UE 115 may not monitor for PDSCH transmissions on the scheduled cells 310 during slots of the time gap 325-a after the PDCCH that conveys the DCI message 315-a, and the UE 115 may not monitor for PDSCH transmissions on the scheduled cells 310 during slots of the time gap 325-b after the PDCCH that conveys the DCI message 315-b. The time gap may be particularly useful for scheduling from low SCS to high SCS (e.g., where the scheduling cell 305 has a lower SCS than the scheduled cells 310) where the PDCCH duration may be multiple PDSCH symbols, in which case the UE 115 would otherwise have to buffer multiple monitored OFDM symbols until the UE 115 performs PDCCH detection and decoding of the DCI message 315, which indicates the actual scheduled PDSCH symbols.

In the case where the scheduled cell(s) 310 have the same SCS (μ_{PDSCH}), and UPDSCH is different from the SCS of the scheduling cell 305 (μ_{PDCCH}) the time gap may be defined as a function of the SCS of the scheduling PDCCH, as shown in Table 1. For example, if μ_{PDCCH}<μ_{PDSCH}, the UE 115 may expect to receive the scheduled PDSCH, if the first symbol in the PDSCH allocation in the DCI message 315, including the demodulation reference signal (DMRS), as defined by the slot offset K₀ and the start and length indicator SLIV of the DCI message 315, starts no earlier than the first symbol of the slot of the PDSCH reception starting at least N_{pdsch} symbols after the end of the PDCCH scheduling the PDSCH (e.g., the PDCCH that conveys the DCI message 315), not accounting for the effect of receive timing differences between the scheduling cell and the scheduled cell.

If μ_{PDCCH}>μ_{PDSCH}, the UE 115 may expect to receive the scheduled PDSCH, if the first symbol in the PDSCH allocation in the DCI message 315, including the DMRS, as defined by the slot offset K₀ and the start and length indicator SLIV of the DCI message 315, starts no earlier than N_{pdsch} symbols after the end of the PDCCH scheduling the PDSCH (e.g., the PDCCH that conveys the DCI message 315), not accounting for the effect of receive timing differences between the scheduling cell and the scheduled cell.

Accordingly, depending on whether μ_{PDCCH} is less than or greater than the μ_{PDSCH}, the time gap may either be the time between the end of the PDCCH scheduling the PDSCH until the first symbol of a slot at least N_{pdsch} symbols after the end of the PDCCH (if μ_{PDCCH}<μ_{PDSCH}) or N_{pdsch} symbols after the end of the PDCCH scheduling the PDSCH (if μ_{PDCCH}>μ_{PDSCH}), where N_{pdsch} is given in Table 1.

TABLE 1
N_{pdsch} as a Function of SCS of the Scheduling PDCCH (μ_{PDCCH})

| SCS | μ_{PDCCH} | N_{pdsch} (symbols) |
|---|---|---|
| 15 kHz | 0 | 4 |
| 30 kHz | 1 | 5 |
| 60 kHz | 2 | 10 |
| 120 kHz | 3 | 14 |
| 480 kHz | 5 | 56 |
| 960 kHz | 6 | 112 |

In this regard, some wireless networks may support techniques for combining multi-cell scheduling and multi-PDSCH/PUSCH scheduling to fully exploit the gain of power saving and PDCCH overhead reduction so that one DCI format 0_3 or 1_3 can schedule multiple cells with one or multiple PUSCHs/PDSCHs per scheduled cell. Such multi-cell scheduling may be particularly useful when a DCI message 315 within the scheduling cell 305 associated with Frequency Range 1 (FR1) and a lower SCS schedules communications on multiple scheduled cells 310 associated with FR2 and a higher SCS.

However, the flexibility and utility of multi-cell scheduling has been hampered or otherwise limited in some wireless communications systems. In particular, some use cases have been excluded from multi-cell scheduling configurations, such as multi-cell scheduling across co-scheduled cells with different SCSs and/or different carrier types. Co-scheduled cells/carriers with different SCSs may have various commercial applications for operators (e.g., 3.5 GHz TDD+Sub-3 GHz FDD, FR1+FR2, etc.).

Stated differently, some wireless communications systems may not allow for multi-carrier scheduling across multiple scheduled cells 310 with different SCSs or carrier types. That is, some wireless communications systems do not allow for a DCI message 315 (e.g., a single DCI message) to schedule communications across multiple scheduled cells 310 with different SCSs and/or different carrier types. For example, referring to FIG. 3A, some wireless communications systems may not enable the DCI message 315-a to schedule the communications within the slots 320-a, 320-b, 320-c, and 320-d if the respective scheduled cells 310-a, 310-b, 310-c, and 310-d are associated with different SCSs and/or carrier types.

As shown in FIG. 3B, in some cases, some wireless communications systems may enable a DCI message 315-c on a scheduling cell 305 to schedule communications with multiple scheduled cells 310 associated with different SCSs (e.g., the scheduled cell 310-e and the scheduled cell 310-f may be associated with a first SCS (shown as 120 kHz) while the scheduled cell 310-g may be associated with a first SCS (shown as 30 kHz)). For example, the DCI message 315-c may schedule communications within the slot 320-e on the scheduled cell 310-e, within the slot 320-f on the scheduled cell 310-f, and within the slot 320-g on the scheduled cell 310-g. The slot 320-g may be the same slot as the slot via which the DCI message 315-c is conveyed, as the scheduled cell 310-g may have the same SCS as the scheduling cell 305, and thus may not demand a time gap.

In the case where scheduled cells 310 have different SCSs, such as in the scheduling configuration 350, defining the time gap as either the time between the end of the PDCCH scheduling the PDSCH until the first symbol of a slot at least N_{pdsch} symbols after the end of the PDCCH (if μ_{PDCCH}<μ_{PDSCH}) or N_{pdsch} symbols after the end of the PDCCH scheduling the PDSCH (if μ_{PDCCH}>μ_{PDSCH}) does not hold as there are multiple μ_{PDSCH} values. For example, one μ_{PDSCH} may be greater than μ_{PDCCH} while another μ_{PDSCH} may be less than μ_{PDCCH}. As another example, some scheduled cells 310 may use the same SCS as the scheduling cell 305 while other scheduled cells 310 may use a different SCS than the scheduling cell. For example, one μ_{PDSCH} may be greater than μ_{PDCCH} while another μ_{PDSCH} may be equal to μ_{PDCCH} (and thus may not involve a time gap). As another example, one μ_{PDSCH} may be less than μ_{PDCCH} while another μ_{PDSCH} may be equal to μ_{PDCCH} (and thus may not involve a time gap). In such cases where multiple scheduled cells 310 use different SCSs, absent additional rules, the time gap may be undefined. For example, the UE 115 and the network entity 105 may support a case where the PDCCH in the scheduling cell 305 and the PDSCH in some scheduled cells 310 are in the same slot, as shown in the scheduling configuration 350.

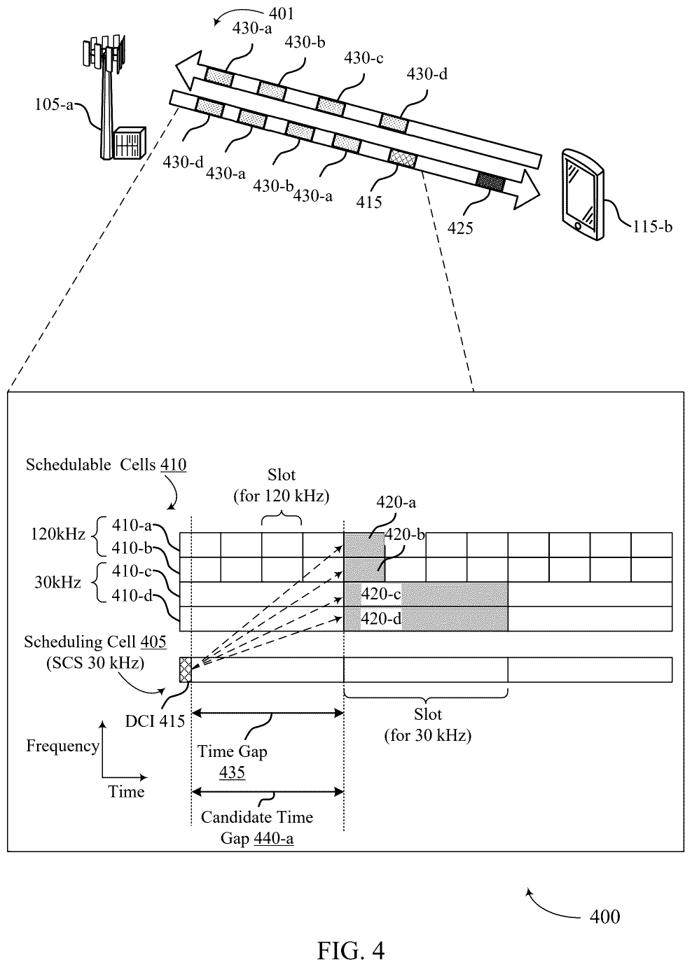

FIG. 4 shows an example of a wireless communications system 400 that supports shared channel preparation time for multi-cell scheduling with different SCSs for scheduled cells in accordance with one or more aspects of the present disclosure. In some examples, aspects of the wireless communications system 400 may implement, or be implemented by, aspects of the wireless communications system 100, the network architecture 200, the scheduling configuration 300, the scheduling configuration 350, or any combination thereof. In particular, the wireless communications system 400 may support signaling, configurations, and DCI formats that are usable for performing multi-cell scheduling across scheduled cells with different SCSs, different carrier types, or both, as described herein.

The wireless communications system 400 may include a network entity 105-a and a UE 115-b, which may be examples of wireless devices as described herein. In some aspects, the network entity 105-a and the UE 115-b may communicate with one another using a communication link 401, which may be an example of an NR or LTE link, sidelink (e.g., PC5 link), and the like, between the respective devices. In some cases, the communication link 401 may include an example of an access link (e.g., Uu link) which may include a bi-directional link that enables both uplink and downlink communication. For example, the UE 115-b may transmit uplink signals, such as uplink control signals or uplink data signals, to one or more components of the network entity 105-a using the communication link 401, and one or more components of the network entity 105-a may transmit downlink signals, such as downlink control signals or downlink data signals, to the UE 115-b using the communication link 401.

As noted previously herein, some wireless communications systems implement cross-cell or multi-cell scheduling. In cross-cell scheduling, the UE 115-b may receive a DCI message 415 via a “scheduling cell 405” that schedules communication(s) (e.g., shared channel communications 430 such as PUSCH or PDSCH communications) on a different “scheduled cell 410.” Similarly, in multi-cell scheduling, the UE 115-a may receive a DCI message 415 via the scheduling cell 405 that schedules communications on multiple different scheduled cells 410. For example, DCI formats 0_3 or 1_3 may be used to schedule up to four cells, and DCI formats 0_3 or 1_3 may schedule up to eight shared channel communications 430 (e.g., PDSCH or PUSCH communications). As noted previously herein, in some cases, the scheduling cell 405 and the scheduled cells 410 may be associated with different frequency ranges or frequency bands. For instance, in some cases, the scheduling cell 405 may be associated with FR1, and the scheduled cells 410 may be associated with FR2 (or vice versa).

Scheduling multiple shared channel communications via a DCI message 415 may save power at the UE 115-b (e.g., by reducing the quantity of PDCCH occasions for the UE 115-b to monitor) and may reduce PDCCH overhead. In some examples, as described herein, a DCI message 415 (e.g., a single DCI message) communicated via a scheduling cell 405 may schedule multiple shared channel communications 430 for communication via multiple scheduled cells 410. For example, the DCI message 415 may schedule a shared channel communication 430-a in a slot 420-a on the scheduled cell 410-a, a shared channel communication 430-b in a slot 420-b on the scheduled cell 410-b, a shared channel communication 430-c in a slot 420-c on the scheduled cell 410-c, and a shared channel communication 430-d in a slot 420-d on the scheduled cell 410-d. In some aspects, the DCI message 415 may include DCI formats 0_3 or 1_3. The shared channel communications 430 may be PDSCH communications or PUSCH communications.

The scheduling cell 405 may be associated with a scheduling cell SCS (e.g., shown as 30 kHz). The scheduled cells may be associated with multiple SCSs. For example, as shown in FIG. 4, the scheduled cell 410-a and the scheduled cell 410-b may be associated with a 120 kHz SCS, and the scheduled cell 410-c and the scheduled cell 410-d may be associated with a 30 kHz SCS. In yet other cases, the scheduled cells 410 may be associated with three or more SCSs (e.g., a first SCS for the scheduled cell 410-a, a second SCS for the scheduled cell 410-b, a third SCS for the scheduled cell 410-c, etc.). In this regard, aspects of the present disclosure are directed to techniques that enable multi-cell scheduling across scheduled cells 410 that are associated with different SCSs and/or different carrier types. In particular, aspects of the present disclosure involve rules for defining the time gap 435 after the DCI message 415 during which the UE 115-b does not expect the DCI to schedule shared channel communications 430.

When the DCI message 415 (e.g., of format 0_3 or 1_3) schedules shared channel communications 430 on multiple scheduled cells 410, where the multiple scheduled cells 410 are associated with at least two different SCSs, the time gap 435 (e.g., the same time gap) may be applied to all of the scheduled cells 410 with respect to the DCI message 415. The one value may be the time gap determined from one of the SCSs of the scheduled cells 410 or schedulable cells.

For example, control signaling 425 such as RRC signaling may indicate which cells may be scheduled by the scheduling cell 405 (e.g., which cells may be scheduled by a DCI format 0_3 or 1_3 on a search space monitored by the UE 115-b on the scheduling cell 405). In some examples, the control signaling 425 may configure the search space(s) for the UE 115-b to monitor on the scheduling cell 405. In some examples, the control signaling 425 may indicate the respective SCS associated with each of the scheduled cells and/or the SCS of the scheduling cell 405.

In some examples (referred to as “option 1”), the time gap 435 (e.g., the UE PDSCH reception preparation time) may be determined based on the highest SCS among the set of SCSs associated with the scheduled cells 410 scheduled cell by the DCI message 415 (e.g., a DCI format 0_3/1_3) in the scheduling cell 405 and the SCS of the scheduling cell 405. For example, as shown in FIG. 4, the highest SCS among the scheduled cells 410 may be 120 kHz (for the scheduled cell 410-a and the scheduled cell 410-b), and accordingly the UE 115-b and the network entity 105-a may compare the 120 KHz highest SCS among the scheduled cells 410 to the 30 kHz SCS of the scheduling cell 405 to determine the time gap 435. In such an example, 120 KHz>30 kHz, and μ_{PDCCH}=1 (e.g., 30 kHz corresponds to μ=1), thus the time gap 435 may be from the end of the PDCCH that conveys the DCI message 415 until the first symbol of the slot starting at least 5 symbols (e.g., based on table 1, when μ_{PDCCH}=1 then N_{pdsch}=5 symbols) after the end of the PDCCH that conveys the DCI message 415.

In some examples (referred to as “option 2”), the time gap 435 (e.g., the UE PDSCH reception preparation time) may be determined based on the lowest SCS among the set of SCSs associated with the scheduled cells 410 scheduled cell by the DCI message 415 (e.g., a DCI format 0_3/1_3) in the scheduling cell 405 and the SCS of the scheduling cell 405. For example, as shown in FIG. 4, the lowest SCS among the scheduled cells 410 may be 30 kHz (for the scheduled cell 410-c and the scheduled cell 410-d), and accordingly the UE 115-b and the network entity 105-a may compare the 30 kHz lowest SCS among the scheduled cells 410 to the 30 kHz SCS of the scheduling cell 405 to determine the time gap 435. In such an example, 30 KHz=30 kHz, and thus no time gap may be used. In the case that one of the scheduled cells 410 was associated with an SCS lower than the SCS of the scheduling cell 405 (e.g., if one of the scheduled cells 410 was associated with an SCS of 15 kHz), then where μ_{PDCCH}=1 (e.g., 30 KHz corresponds to μ=1), the time gap 435 would be at least 5 symbols (e.g., based on table 1, when μ_{PDCCH}=1 then N_{pdsch}=5 symbols) after the end of the PDCCH that conveys the DCI message 415.

In some examples (referred to as “option 3”), the time gap 435 (e.g., the UE PDSCH reception preparation time) may be determined as the longest time gap from a set of candidate time gaps 440 based on comparisons of the multiple SCSs of the multiple scheduled cells 410 to the SCS of the scheduling cell 405. Such an example may exclude the time gap 435 from being “0” symbols as at least one of the SCSs of the scheduled cells 410 may be different from the SCS of the scheduling cell 405. For example, as shown in FIG. 4, the SCS for the scheduled cell 410-a and the scheduled cell 410-b is 120 kHz, which is greater than the 30 kHz SCS of the scheduling cell 405. As μ_{PDCCH}<μ_{PDSCH} for the scheduled cell 410-a and the scheduled cell 410-b, and μ_{PDCCH}=1 (e.g., 30 kHz corresponds to μ=1), the candidate time gap 440-a for the scheduled cell 410-a and the scheduled cell 410-b may be from the end of the PDCCH that conveys the DCI message 415 until the first symbol of the slot starting at least 5 symbols (e.g., based on table 1, when μ_{PDCCH}=1 then N_{pdsch}=5 symbols) after the end of the PDCCH that conveys the DCI message 415. The SCS for the scheduled cell 410-c and the scheduled cell 410-d is 30 kHz, which is equal to the 30 kHz SCS of the scheduling cell 405, and accordingly the candidate time gap for the scheduled cell 410-c and the scheduled cell 410-d may be “0.” Accordingly, in option 3, the UE 115-b and the network entity 105-a may determine the time gap 435 to apply to all of the scheduled cells 410 as extending from the end of the PDCCH that conveys the DCI message 415 until the first symbol of the slot starting at least 5 symbols after the end of the PDCCH that conveys the DCI message 415.

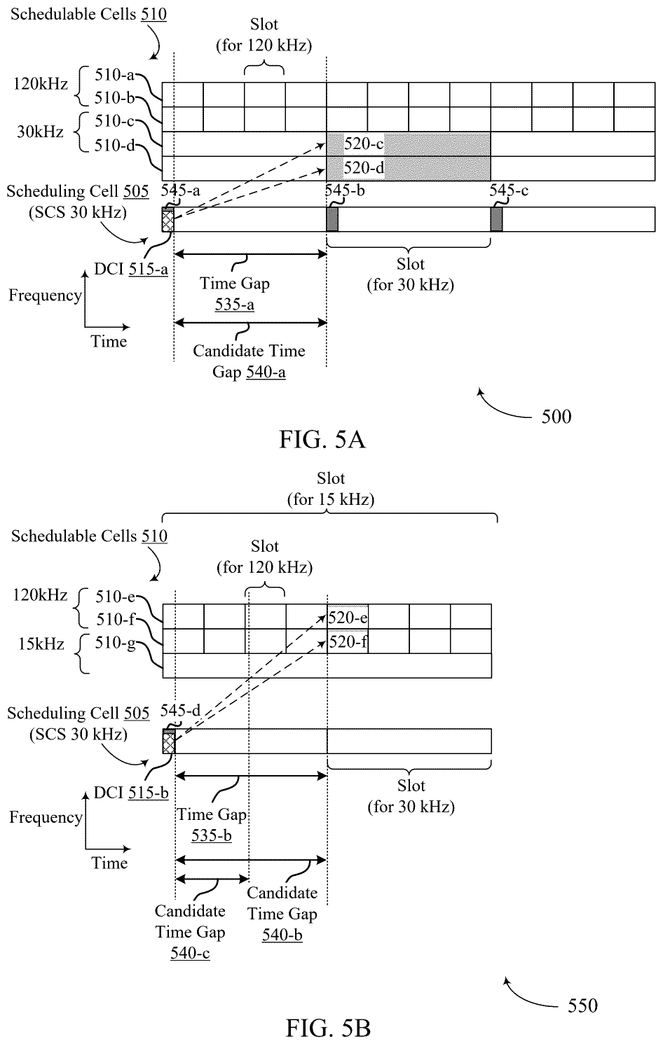

FIG. 5A shows an example of a scheduling configuration 500 that supports shared channel preparation time for multi-cell scheduling with different SCSs for scheduled cells in accordance with one or more aspects of the present disclosure. FIG. 5B shows an example of a scheduling configuration 550 that supports shared channel preparation time for multi-cell scheduling with different SCSs for scheduled cells in accordance with one or more aspects of the present disclosure. In some examples, aspects of the scheduling configuration 500 or the scheduling configuration 550 may implement, or be implemented by, aspects of the wireless communications system 100, the network architecture 200, the scheduling configuration 300, the scheduling configuration 350, the wireless communications system 400, or any combination thereof.

As described herein, a network entity 105 may indicate, to a UE 115 via control signaling (e.g., control signaling 425 as described with reference to FIG. 4), which cells may be scheduled by a scheduling cell 505 (e.g., which cells may be scheduled by a DCI format 0_3 or 1_3 on a search space 545 monitored by the UE 115 on the scheduling cell 505). For example, the UE 115 may be configured to monitor a search space 545-a in a first slot of the scheduling cell 505, a search space 545-b in a second slot of the scheduling cell 505, and a search space 545-c in a third slot of the scheduling cell 505. The cells which may be scheduled by a scheduling cell 505 may be referred to as schedulable cells 510.

As shown in the scheduling configuration 500 of FIG. 5A, a DCI message 515-a (e.g., a DCI format 0_3 or 1_3) received via the search space 545-a may schedule shared channel communications (e.g., PUSCH or PDSCH transmissions such as the shared channel communications 430 as described with reference to FIG. 4) on multiple of the schedulable cells 510. In some examples, the DCI message 515-a may schedule shared channel communications on less than all of the schedulable cells. For example, the DCI message 515-a may schedule a shared channel communication in a slot 520-c on the schedulable cell 510-c and a shared channel communication in a slot 520-d on the schedulable cell 510-d (e.g., and may not schedule shared channel communications on the schedulable cell 510-a or the schedulable cell 510-b).

In some such examples, the time gap 535-a may be based on the SCSs of the cells scheduled by the DCI message 515-a (e.g., option 1, option 2, or option 3 as described with reference to FIG. 4). In such examples, however, if SCS of at least one of the schedulable cells 510 is the same as the SCS of the scheduling cell 505, then possible the time gap may be “0” and the UE 115 may have to store OFDM symbols for the schedulable cells 510 until the UE 115 decodes the DCI message 515-a and determines which cells are actually scheduled. Accordingly, in some examples, the time gap 535-a may be determined based on the SCSs of the cells that are schedulable by the scheduling cell 505 (e.g., which cells may be scheduled by a DCI format 0_3 or 1_3 on a search space monitored by the UE 115 on the scheduling cell 505). The time gap 535-a may be commonly applied to all schedulable cells 510 for a DCI message 515-a received via the scheduling cell 505, regardless of which cells the DCI message 515-a actually schedules.

In some examples (referred to as “option 1A”), the time gap 535-a (e.g., the UE PDSCH reception preparation time) may be determined based on the highest SCS among the set of SCSs associated with the schedulable cells 510 and the SCS of the scheduling cell 505. For example, as shown in FIG. 5A, the highest SCS among the schedulable cells 510 may be 120 kHz (for the schedulable cell 510-a and the schedulable cell 510-b), and accordingly the UE 115-b and the network entity 105-a may compare the 120 kHz highest SCS among the schedulable cells 510 to the 30 kHz SCS of the scheduling cell 505 to determine the time gap 435. In such an example, 120 KHz>30 kHz, and μ_{PDCCH}=1 (e.g., 30 kHz corresponds to μ=1), thus the time gap 435 may be from the end of the PDCCH that conveys the DCI message 515-a until the first symbol of the slot starting at least 5 symbols (e.g., based on table 1, when μ_{PDCCH}=1 then N_{pdsch}=5 symbols) after the end of the PDCCH that conveys the DCI message 515-a, as determined based on the SCSs of the schedulable cell 510-a and the schedulable cell 510-b even though the DCI message 515-a does not schedule a communication on the schedulable cell 510-a or the schedulable cell 510-b.

In some examples (referred to as “option 2A”), the time gap 535-a (e.g., the UE PDSCH reception preparation time) may be determined based on the lowest SCS among the set of SCSs associated with the schedulable cells 510 and the SCS of the scheduling cell 505. For example, as shown in FIG. 5A, the lowest SCS among the schedulable cells 510 may be 30 kHz (for the schedulable cell 510-c and the schedulable cell 510-d), and accordingly the UE 115-b and the network entity 105-a may compare the 30 kHz lowest SCS among the schedulable cells 510 to the 30 kHz SCS of the scheduling cell 505 to determine the time gap 535-a. In such an example, 30 KHz=30 kHz, and thus no time gap may be used. In the case that one of the schedulable cells 510 was associated with an SCS lower than the SCS of the scheduling cell 505 (e.g., if one of the schedulable cells 510 was associated with an SCS of 15 kHz), then where μ_{PDCCH}=1 (e.g., 30 kHz corresponds to μ=1), the time gap 535-a would be at least 5 symbols (e.g., based on table 1, when μ_{PDCCH}=1 then N_{pdsch}=5 symbols) after the end of the PDCCH that conveys the DCI message 515-a.

In some examples (referred to as “option 3A”), the time gap 535-a (e.g., the UE PDSCH reception preparation time) may be determined as the longest time gap from a set of candidate time gaps based on comparisons of the multiple SCSs of the multiple schedulable cells 510 to the SCS of the scheduling cell 505. Such an example may exclude the time gap 535-a from being “0” symbols as at least one of the SCSs of the schedulable cells 510 may be different from the SCS of the scheduling cell 505. For example, as shown in FIG. 5A, the SCS for the schedulable cell 510-a and the schedulable cell 510-b is 120 kHz, which is greater than the 30 kHz SCS of the scheduling cell 505. As μ_{PDCCH}<μ_{PDSCH} for the schedulable cell 510-a and the schedulable cell 510-b, and μ_{PDCCH}=1 (e.g., 30 kHz corresponds to μ=1), the candidate time gap 540-a for the schedulable cell 510-a and the schedulable cell 510-b may be from the end of the PDCCH that conveys the DCI message 515-a until the first symbol of the slot starting at least 5 symbols after the end of the PDCCH that conveys the DCI message 515-a. The SCS for the schedulable cell 510-c and the schedulable cell 510-d is 30 kHz, which is equal to the 30 kHz SCS of the scheduling cell 505, and accordingly the candidate time gap for the schedulable cell 510-c and the schedulable cell 510-d may be “0.” Accordingly, in option 3A, the UE 115 and the network entity 105 may determine the time gap 535-a to apply to all of the schedulable cells 510 as extending from the end of the PDCCH that conveys the DCI message 515-a until the first symbol of the slot starting at least 5 symbols after the end of the PDCCH that conveys the DCI message 515-a.

In some examples, as shown in the scheduling configuration 550 of FIG. 5B, some schedulable cells 510 may have SCSs lower than the SCS of the scheduling cell and some schedulable cells may have SCSs higher than the SCS of the scheduled cell. For example, the schedulable cell 510-e and the schedulable cell 510-e may have an SCS of 120 kHz, which is greater than the 30 kHz SCS of the scheduling cell 505, and the schedulable cell 510-g and the schedulable cell 510-g may have an SCS of 15 kHz, which is less than the 15 kHz SCS of the scheduling cell 505. The DCI message 515-b received via the search space 545-d may schedule a shared channel communication in a slot 520-e on the schedulable cell 510-e and a shared channel communication in a slot 520-f on the schedulable cell 510-f (e.g., and may not schedule shared channel communications on the schedulable cell 510-g).

In Option 3A the time gap 535-a (e.g., the UE PDSCH reception preparation time) may be determined as the longest time gap from a set of candidate time gaps 540 based on comparisons of the multiple SCSs of the multiple schedulable cells 510 to the SCS of the scheduling cell 505. For example, as shown in FIG. 5B, the SCS for the schedulable cell 510-e and the schedulable cell 510-f is 120 kHz, which is greater than the 30 kHz SCS of the scheduling cell 505. As μ_{PDCCH}<μ_{PDSCH} for the schedulable cell 510-c and the schedulable cell 510-f, and μ_{PDCCH}=1 (e.g., 30 kHz corresponds to μ=1), the candidate time gap 540-b for the schedulable cell 510-e and the schedulable cell 510-f may be from the end of the PDCCH that conveys the DCI message 515-b until the first symbol of the slot starting at least 5 symbols after the end of the PDCCH that conveys the DCI message 515-b. Further, the SCS for the schedulable cell 510-g is 15 kHz, which is less than the 30 kHz SCS of the scheduling cell 505. As μ_{PDCCH}>μ_{PDSCH} for the schedulable cell 510-g, and μ_{PDCCH}=1 (e.g., 30 kHz corresponds to μ=1), the candidate time gap 540-b for the schedulable cell 510-e and the schedulable cell 510-f may be from the end of the PDCCH that conveys the DCI message 515-b until 5 symbols after the end of the PDCCH that conveys the DCI message 515-b. As the candidate time gap 540-b is longer than the candidate time gap 540-c, the UE 115 may determine or select the candidate time gap 540-b as the time gap 535-b.

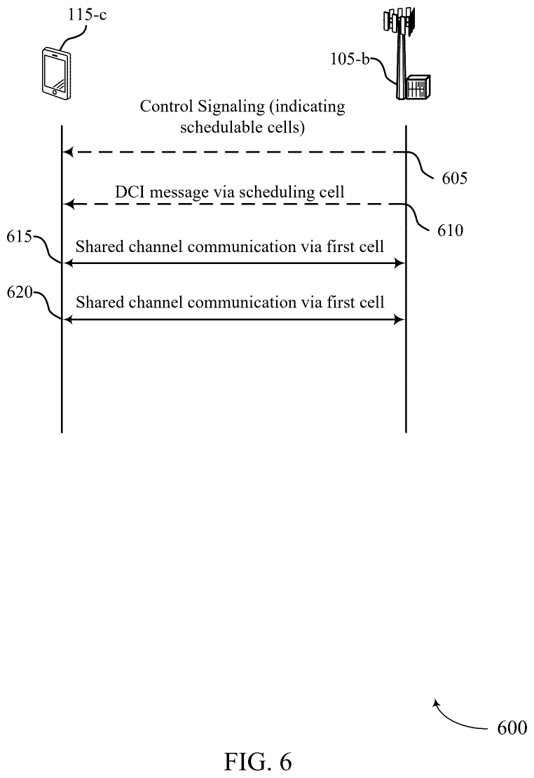

FIG. 6 shows an example of a process flow 600 that supports shared channel preparation time for multi-cell scheduling with different SCSs for scheduled cells in accordance with one or more aspects of the present disclosure. In some examples, aspects of the process flow 600 may implement, or be implemented by, aspects of the wireless communications system 100, the network architecture 200, the scheduling configuration 300, the scheduling configuration 350, the wireless communications system 400, the scheduling configuration 500, the scheduling configuration 550, or any combination thereof. The process flow 600 includes a network entity 105-b and a UE 115-c, which may be examples of wireless devices as described herein. For example, the network entity 105-b and the UE 115-c illustrated in FIG. 6 may include examples of the network entity 105-a and the UE 115-b, respectively, as illustrated in FIG. 4.

In some examples, the operations illustrated in process flow 600 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 610, the network entity 105-b may output, and the UE 115-c may receive, via a third cell associated with a third cell subcarrier spacing, a message that schedules a first shared channel communication via (e.g., on) a first cell associated with a first SCS and a second shared channel communication via (e.g., on) a second cell associated with a second SCS. The first SCS may be different than the second SCS. In some examples, the message may be a DCI message.

At 615, the network entity 105-b and the UE 115-c may participate in the first shared channel communication via the first cell at least a time gap after reception of the DCI message. The time gap may be based on the scheduling cell SCS, the first SCS, and the second SCS.

At 620, the network entity 105-b and the UE 115-c may participate in the second shared channel communication via the second cell at least the time gap after reception of the DCI message.

In some examples, the time gap may be based on a highest SCS from among a set of SCSs associated with a set of cells scheduled by the DCI message, where the set of cells includes the first cell and the second cell, and where the set of SCSs includes the first SCS and the second SCS. For example, the time gap may be determined in accordance with option 1 as described herein.

In some examples, the time gap may be based on a lowest SCS from among a set of SCSs associated with a set of cells scheduled by the DCI message, where the set of cells includes the first cell and the second cell, and where the set of SCSs includes the first SCS and the second SCS. For example, the time gap may be determined in accordance with option 2 as described herein.

In some examples, the time gap may be a largest time gap from a set of candidate time gaps, where the set of candidate time gaps are based on respective comparisons between the scheduling cell SCS and a set of SCSs associated with a set of cells scheduled by the DCI message, where the set of cells includes the first cell and the second cell, and where the set of SCSs includes the first SCS and the second SCS. For example, the time gap may be determined in accordance with option 3 as described herein.

In some examples, at 605, the network entity 105-b may output, and the UE 115-c may receive, control signaling that indicates a set of cells schedulable by DCI in a search space configured to be monitored by the UE 115-c on the scheduling cell. The set of cells may include the first cell and the second cell. In some such examples, the time gap may be based on a highest SCS from among a set of SCSs associated with the set of cells, and the set of SCSs may include the first SCS and the second SCS. For example, the time gap may be determined in accordance with option 1A as described herein. In other such examples, the time gap may be based on a lowest SCS from among a set of SCSs associated with the set of cells, and the set of SCSs may include the first SCS and the second SCS. For example, the time gap may be determined in accordance with option 2A as described herein. In other such examples, the time gap may be a largest time gap from a set of candidate time gaps, where the set of candidate time gaps are based on respective comparisons between the scheduling cell SCS and a set of SCSs associated with the set of cells, and where the set of SCSs includes the first SCS and the second SCS. For example, the time gap may be determined in accordance with option 3A as described herein.

In some examples, the network entity 105-b and the UE 115-c may participate in a third shared channel communication via a third cell associated with a third SCS at least the time gap after reception of the DCI message, where the DCI message schedules the third shared channel communication via the third cell, and where the time gap is further based on the third SCS. For example, the DCI message may schedule more than two shared channel communications on more than two cells having multiple respective SCSs.

In some examples, at least one of the first SCS or the second SCS may be the same as the scheduling cell SCS.

In some examples, where the control signaling at 605 indicates the set of cells schedulable by the scheduling cell, the UE 115-c may refrain from monitoring for respective downlink shared channel transmissions via the set of cells during the time gap, and the UE 115-c may monitor for the respective downlink shared channel transmissions via the set of cells after the time gap. Participating in the first shared channel communication at 615 or the second shared channel communication at 620 may be based on the monitoring.

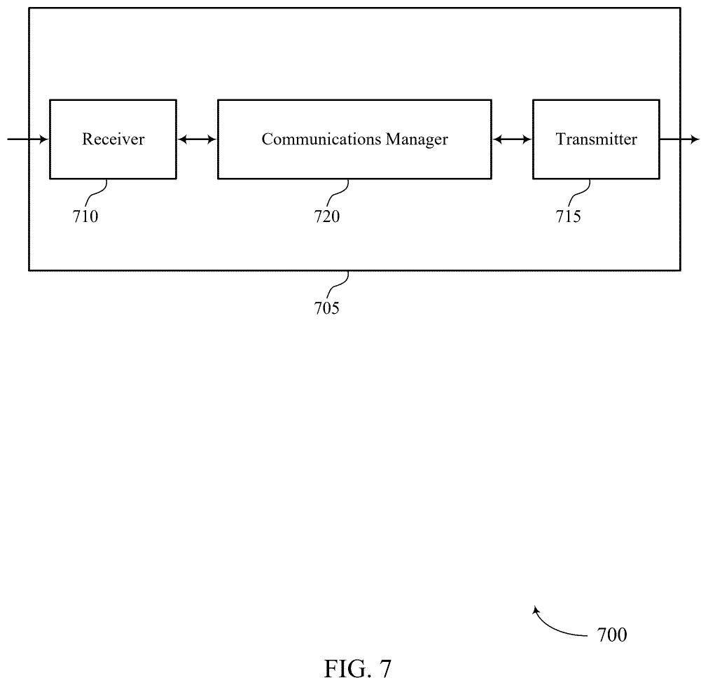

FIG. 7 shows a block diagram 700 of a device 705 that supports shared channel preparation time for multi-cell scheduling with different SCSs for scheduled cells in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to shared channel preparation time for multi-cell scheduling with different SCSs for scheduled cells). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to shared channel preparation time for multi-cell scheduling with different SCSs for scheduled cells). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of shared channel preparation time for multi-cell scheduling with different SCSs for scheduled cells as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving, via a third cell associated with a third cell subcarrier spacing, a message that schedules a first shared channel communication via a first cell associated with a first SCS and a second shared channel communication via a second cell associated with a second SCS, where the first SCS is different than the second SCS. The communications manager 720 is capable of, configured to, or operable to support a means for participating in the first shared channel communication via the first cell at least a time gap after reception of the message, where the time gap is based on the third cell SCS, the first SCS, and the second SCS. The communications manager 720 is capable of, configured to, or operable to support a means for participating in the second shared channel communication via the second cell at least the time gap after reception of the message. In some examples, the message may be a DCI message.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

The communications manager 720 may be an example of means for performing various aspects of managing shared channel preparation time for multi-cell scheduling with different SCSs for scheduled cells as described herein. The communications manager 720, or its sub-components, may be implemented in hardware (e.g., in communications management circuitry). The circuitry may comprise of processor, DSP, an ASIC, an FPGA, or other programmable logic device, discrete gate or transistor logic, discrete hardware components, or any combination thereof designed to perform the functions described in the present disclosure.

In another implementation, the communications manager 720, or its sub-components, may be implemented in code (e.g., as communications management software or firmware) executed by a processor, or any combination thereof. If implemented in code executed by a processor, the functions of the communications manager 720, or its sub-components may be executed by a general-purpose processor, a DSP, an ASIC, an FPGA, or other programmable logic device.

In some examples, the communications manager 720 may be configured to perform various operations (e.g., receiving, participating in, transmitting) using or otherwise in cooperation with the receiver 710, the transmitter 715, or both.

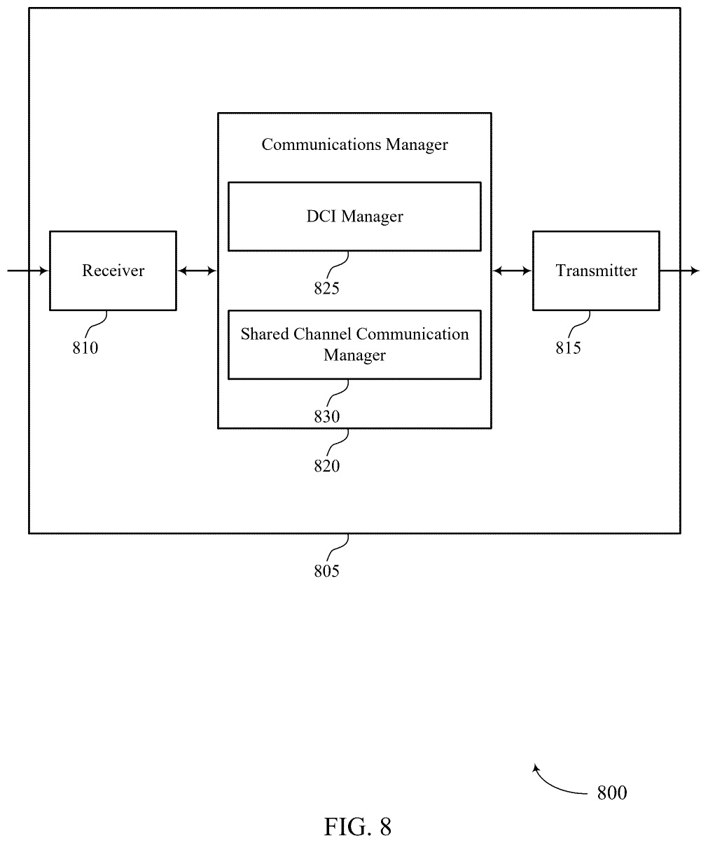

FIG. 8 shows a block diagram 800 of a device 805 that supports shared channel preparation time for multi-cell scheduling with different SCSs for scheduled cells in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to shared channel preparation time for multi-cell scheduling with different SCSs for scheduled cells). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to shared channel preparation time for multi-cell scheduling with different SCSs for scheduled cells). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of shared channel preparation time for multi-cell scheduling with different SCSs for scheduled cells as described herein. For example, the communications manager 820 may include a DCI manager 825 a shared channel communication manager 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The DCI manager 825 is capable of, configured to, or operable to support a means for receiving, via a third cell associated with a third cell subcarrier spacing, a message that schedules a first shared channel communication via a first cell associated with a first SCS and a second shared channel communication via a second cell associated with a second SCS, where the first SCS is different than the second SCS. The shared channel communication manager 830 is capable of, configured to, or operable to support a means for participating in the first shared channel communication via the first cell at least a time gap after reception of the message, where the time gap is based on the third cell SCS, the first SCS, and the second SCS. The shared channel communication manager 830 is capable of, configured to, or operable to support a means for participating in the second shared channel communication via the second cell at least the time gap after reception of the message. In some examples, the message may be a DCI message.

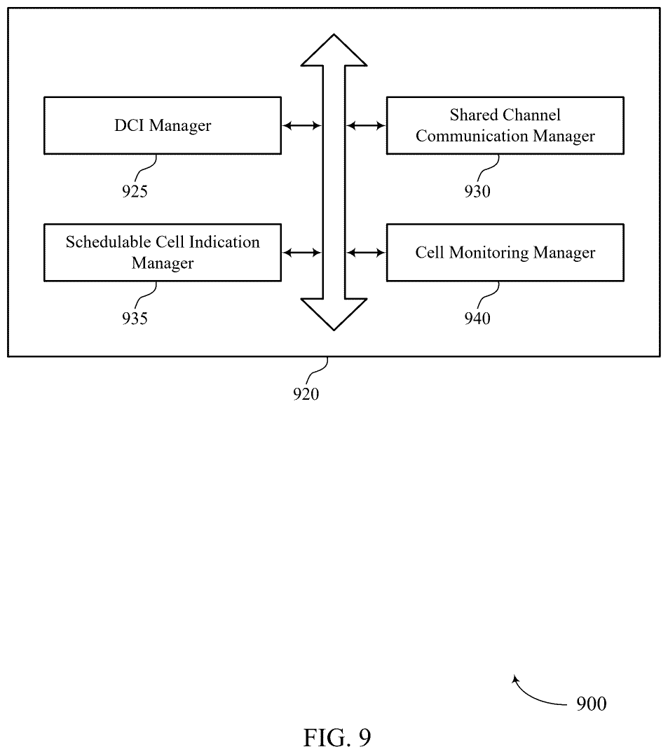

FIG. 9 shows a block diagram 900 of a communications manager 920 that supports shared channel preparation time for multi-cell scheduling with different SCSs for scheduled cells in accordance with one or more aspects of the present disclosure. The communications manager 920 may be an example of aspects of a communications manager 720, a communications manager 820, or both, as described herein. The communications manager 920, or various components thereof, may be an example of means for performing various aspects of shared channel preparation time for multi-cell scheduling with different SCSs for scheduled cells as described herein. For example, the communications manager 920 may include a DCI manager 925, a shared channel communication manager 930, a schedulable cell indication manager 935, a cell monitoring manager 940, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The DCI manager 925 is capable of, configured to, or operable to support a means for receiving, via a third cell associated with a third cell subcarrier spacing, a message that schedules a first shared channel communication via a first cell associated with a first SCS and a second shared channel communication via a second cell associated with a second SCS, where the first SCS is different than the second SCS. The shared channel communication manager 930 is capable of, configured to, or operable to support a means for participating in the first shared channel communication via the first cell at least a time gap after reception of the message, where the time gap is based on the third cell SCS, the first SCS, and the second SCS. In some examples, the shared channel communication manager 930 is capable of, configured to, or operable to support a means for participating in the second shared channel communication via the second cell at least the time gap after reception of the message. In some examples, the message may be a DCI message.

In some examples, the time gap is based on a highest SCS from among a set of SCSs associated with a set of cells scheduled by the message. In some examples, the set of cells includes the first cell and the second cell. In some examples, the set of SCSs includes the first SCS and the second SCS.

In some examples, the time gap is based on a lowest SCS from among a set of SCSs associated with a set of cells scheduled by the message. In some examples, the set of cells includes the first cell and the second cell. In some examples, the set of SCSs includes the first SCS and the second SCS.

In some examples, the time gap is a largest time gap from a set of candidate time gaps. In some examples, the set of candidate time gaps are based on respective comparisons between the third cell SCS and a set of SCSs associated with a set of cells scheduled by the message. In some examples, the set of cells includes the first cell and the second cell. In some examples, the set of SCSs includes the first SCS and the second SCS.

In some examples, the schedulable cell indication manager 935 is capable of, configured to, or operable to support a means for receiving control signaling that indicates a set of cells schedulable by DCI in a search space monitored on the third cell, where the set of cells includes the first cell and the second cell, where the time gap is based on a highest SCS from among a set of SCSs associated with the set of cells, and where the set of SCSs includes the first SCS and the second SCS.

In some examples, the schedulable cell indication manager 935 is capable of, configured to, or operable to support a means for receiving control signaling that indicates a set of cells schedulable by DCI in a search space monitored on the third cell, where the set of cells includes the first cell and the second cell, where the time gap is based on a lowest SCS from among a set of SCSs associated with the set of cells, and where the set of SCSs includes the first SCS and the second SCS.

In some examples, the schedulable cell indication manager 935 is capable of, configured to, or operable to support a means for receiving control signaling that indicates a set of cells schedulable by DCI in a search space monitored on the third cell, where the set of cells includes the first cell and the second cell, where the time gap is a largest time gap from a set of candidate time gaps, where the set of candidate time gaps are based on respective comparisons between the third cell SCS and a set of SCSs associated with the set of cells, and where the set of SCSs includes the first SCS and the second SCS.

In some examples, the shared channel communication manager 930 is capable of, configured to, or operable to support a means for participating in a third shared channel communication via a third cell associated with a third SCS at least the time gap after reception of the message, where the message schedules the third shared channel communication via the third cell, where the time gap is based on the third SCS.

In some examples, at least one of the first SCS or the second SCS is a same as the third cell SCS.

In some examples, the schedulable cell indication manager 935 is capable of, configured to, or operable to support a means for receiving control signaling that indicates a set of cells schedulable by DCI in a search space monitored on the third cell, where the set of cells includes the first cell and the second cell. In some examples, the cell monitoring manager 940 is capable of, configured to, or operable to support a means for refraining from monitoring for respective downlink shared channel transmissions via the set of cells during the time gap. In some examples, the cell monitoring manager 940 is capable of, configured to, or operable to support a means for monitoring for the respective downlink shared channel transmissions via the set of cells after the time gap, where participation in the first shared channel communication or the second shared channel communication is based at least on the monitoring.

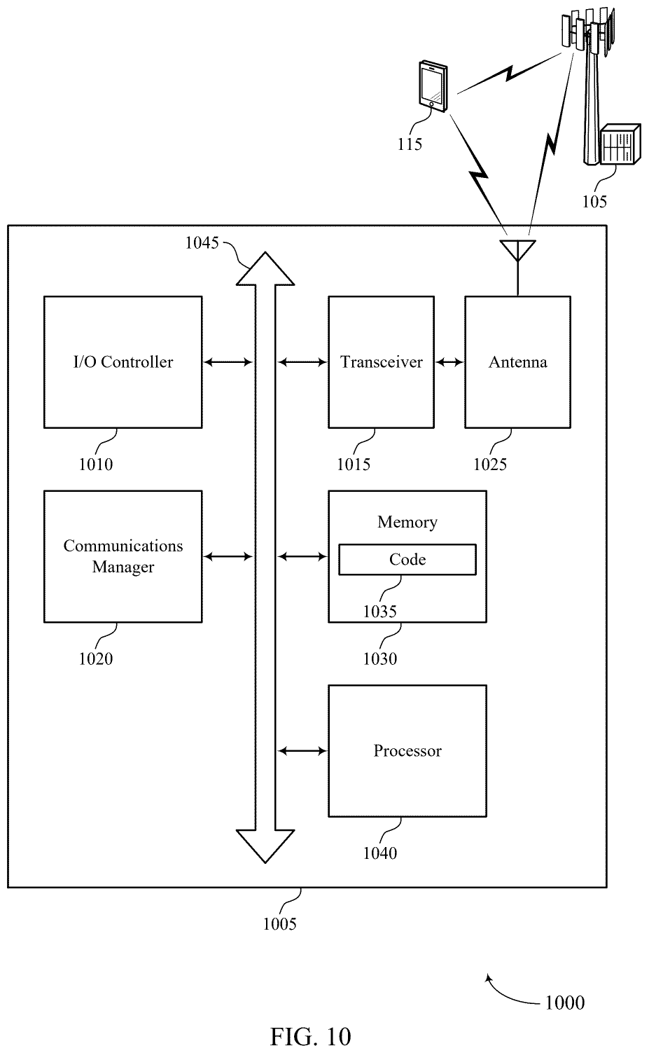

FIG. 10 shows a diagram of a system 1000 including a device 1005 that supports shared channel preparation time for multi-cell scheduling with different SCSs for scheduled cells in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting shared channel preparation time for multi-cell scheduling with different SCSs for scheduled cells). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving, via a third cell associated with a third cell subcarrier spacing, a message that schedules a first shared channel communication via a first cell associated with a first SCS and a second shared channel communication via a second cell associated with a second SCS, and where the first SCS is different than the second SCS. The communications manager 1020 is capable of, configured to, or operable to support a means for participating in the first shared channel communication via the first cell at least a time gap after reception of the message, where the time gap is based on the third cell SCS, the first SCS, and the second SCS. The communications manager 1020 is capable of, configured to, or operable to support a means for participating in the second shared channel communication via the second cell at least the time gap after reception of the message. In some examples, the message may be a DCI message.

By including or configuring the communications manager 1020 in accordance with examples as described herein, the device 1005 may support techniques for improved communication reliability, reduced latency, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of shared channel preparation time for multi-cell scheduling with different SCSs for scheduled cells as described herein, or the at least one processor 1040 and the at least one memory 1030 may be otherwise configured to, individually or collectively, perform or support such operations.

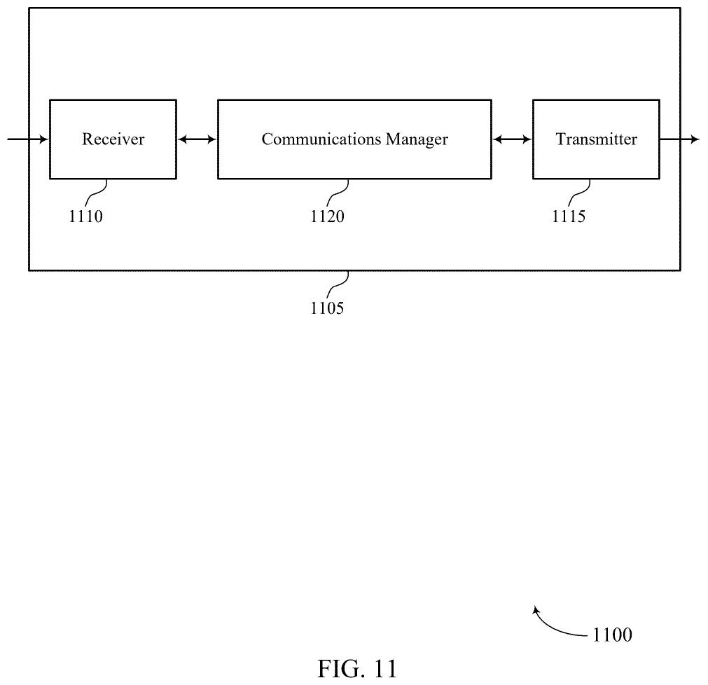

FIG. 11 shows a block diagram 1100 of a device 1105 that supports shared channel preparation time for multi-cell scheduling with different SCSs for scheduled cells in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of shared channel preparation time for multi-cell scheduling with different SCSs for scheduled cells as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting, via a third cell associated with a third cell subcarrier spacing, a message that schedules a first shared channel communication via a first cell associated with a first SCS and a second shared channel communication via a second cell associated with a second SCS, and where the first SCS is different than the second SCS. The communications manager 1120 is capable of, configured to, or operable to support a means for participating in the first shared channel communication via the first cell at least a time gap after output of the message where the time gap is based on the third cell SCS, the first SCS, and the second SCS. The communications manager 1120 is capable of, configured to, or operable to support a means for participating in the second shared channel communication via the second cell at least the time gap after output of the message. In some examples, the message may be a DCI message.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources.

The communications manager 1120 may be an example of means for performing various aspects of managing shared channel preparation time for multi-cell scheduling with different SCSs for scheduled cells as described herein. The communications manager 1120, or its sub-components, may be implemented in hardware (e.g., in communications management circuitry). The circuitry may comprise of processor, DSP, an ASIC, an FPGA, or other programmable logic device, discrete gate or transistor logic, discrete hardware components, or any combination thereof designed to perform the functions described in the present disclosure.

In another implementation, the communications manager 1120, or its sub-components, may be implemented in code (e.g., as communications management software or firmware) executed by a processor, or any combination thereof. If implemented in code executed by a processor, the functions of the communications manager 1120, or its sub-components may be executed by a general-purpose processor, a DSP, an ASIC, an FPGA, or other programmable logic device.

In some examples, the communications manager 1120 may be configured to perform various operations (e.g., outputting, participating in, obtaining) using or otherwise in cooperation with the receiver 1110, the transmitter 1115, or both.

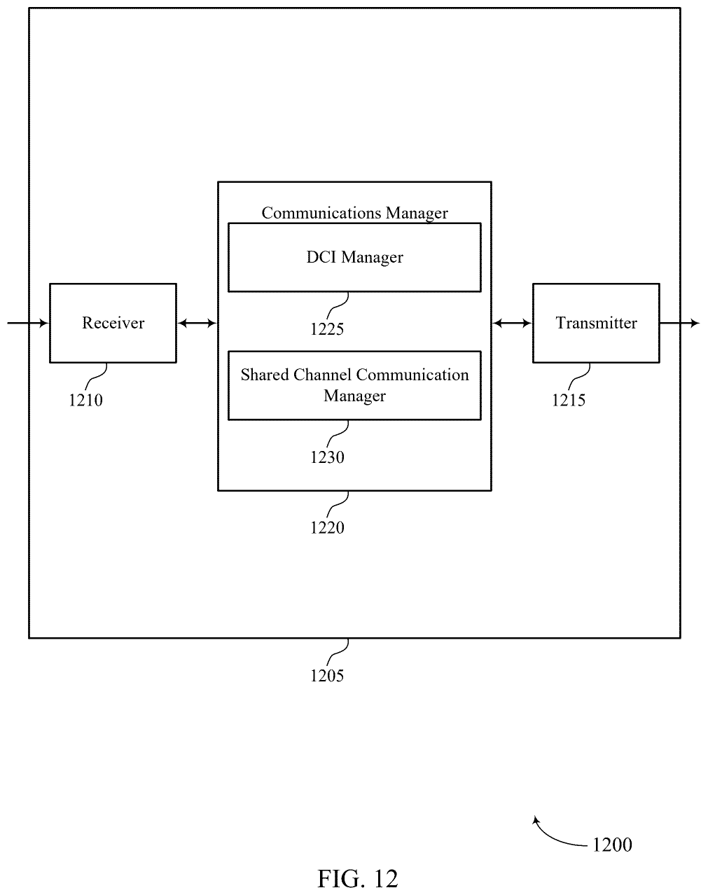

FIG. 12 shows a block diagram 1200 of a device 1205 that supports shared channel preparation time for multi-cell scheduling with different SCSs for scheduled cells in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of shared channel preparation time for multi-cell scheduling with different SCSs for scheduled cells as described herein. For example, the communications manager 1220 may include a DCI manager 1225 a shared channel communication manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The DCI manager 1225 is capable of, configured to, or operable to support a means for outputting, via a third cell associated with a third cell subcarrier spacing, a message that schedules a first shared channel communication via a first cell associated with a first SCS and a second shared channel communication via a second cell associated with a second SCS, where the first SCS is different than the second SCS. The shared channel communication manager 1230 is capable of, configured to, or operable to support a means for participating in the first shared channel communication via the first cell at least a time gap after output of the message where the time gap is based on the third cell SCS, the first SCS, and the second SCS. The 1235 is capable of, configured to, or operable to support a means for participating in the second shared channel communication via the second cell at least the time gap after output of the message. In some examples, the message may be a DCI message.

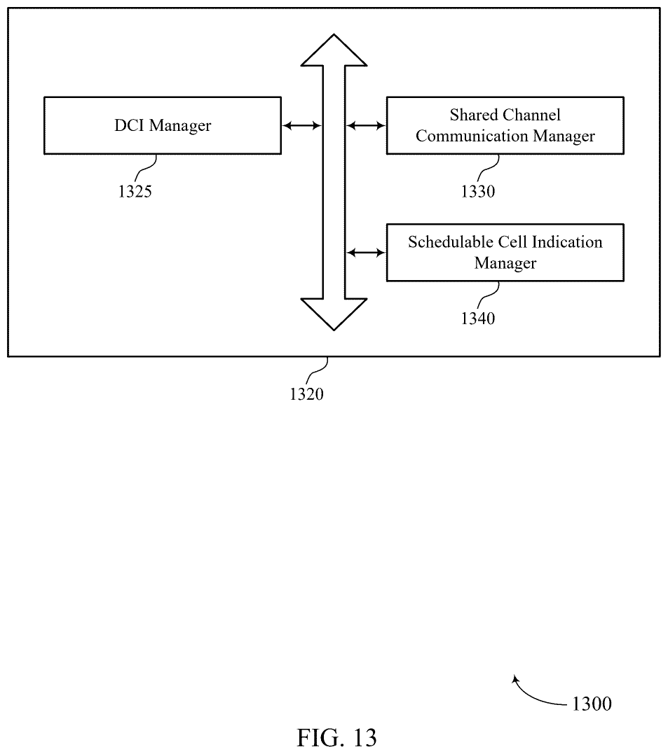

FIG. 13 shows a block diagram 1300 of a communications manager 1320 that supports shared channel preparation time for multi-cell scheduling with different SCSs for scheduled cells in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of shared channel preparation time for multi-cell scheduling with different SCSs for scheduled cells as described herein. For example, the communications manager 1320 may include a DCI manager 1325, a shared channel communication manager 1330, a schedulable cell indication manager 1340, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The DCI manager 1325 is capable of, configured to, or operable to support a means for outputting, via a third cell associated with a third cell subcarrier spacing, a message that schedules a first shared channel communication via a first cell associated with a first SCS and a second shared channel communication via a second cell associated with a second SCS, and where the first SCS is different than the second SCS. The shared channel communication manager 1330 is capable of, configured to, or operable to support a means for participating in the first shared channel communication via the first cell at least a time gap after output of the message where the time gap is based on the third cell SCS, the first SCS, and the second SCS. The shared channel communication manager 1330 is capable of, configured to, or operable to support a means for participating in the second shared channel communication via the second cell at least the time gap after output of the message. In some examples, the message may be a DCI message.

In some examples, the time gap is based on a highest SCS from among a set of SCSs associated with a set of cells scheduled by the message. In some examples, the set of cells includes the first cell and the second cell. In some examples, the set of SCSs includes the first SCS and the second SCS.

In some examples, the time gap is based on a lowest SCS from among a set of SCSs associated with a set of cells scheduled by the message. In some examples, the set of cells includes the first cell and the second cell. In some examples, the set of SCSs includes the first SCS and the second SCS.

In some examples, the time gap is a largest time gap from a set of candidate time gaps. In some examples, the set of candidate time gaps are based on respective comparisons between the third cell SCS and a set of SCSs associated with a set of cells scheduled by the message. In some examples, the set of cells includes the first cell and the second cell. In some examples, the set of SCSs includes the first SCS and the second SCS.

In some examples, the schedulable cell indication manager 1340 is capable of, configured to, or operable to support a means for outputting control signaling that indicates a set of cells schedulable by DCI in a search space configured for the third cell, where the set of cells includes the first cell and the second cell, where the time gap is based on a highest SCS from among a set of SCSs associated with the set of cells, and where the set of SCSs includes the first SCS and the second SCS.

In some examples, the schedulable cell indication manager 1340 is capable of, configured to, or operable to support a means for outputting control signaling that indicates a set of cells schedulable by DCI in a search space configured for the third cell, where the set of cells includes the first cell and the second cell, where the time gap is based on a lowest SCS from among a set of SCSs associated with the set of cells, and where the set of SCSs includes the first SCS and the second SCS.

In some examples, the schedulable cell indication manager 1340 is capable of, configured to, or operable to support a means for outputting control signaling that indicates a set of cells schedulable by DCI in a search space configured for the third cell, where the set of cells includes the first cell and the second cell, where the time gap is a largest time gap from a set of candidate time gaps, where the set of candidate time gaps are based on respective comparisons between the third cell SCS and a set of SCSs associated with the set of cells, and where the set of SCSs includes the first SCS and the second SCS.

In some examples, the shared channel communication manager 1330 is capable of, configured to, or operable to support a means for participating in a third shared channel communication via a third cell associated with a third SCS at least the time gap after output of the message, where the message schedules the third shared channel communication via the third cell, where the time gap is based on the third SCS.

In some examples, at least one of the first SCS or the second SCS is a same as the third cell SCS.

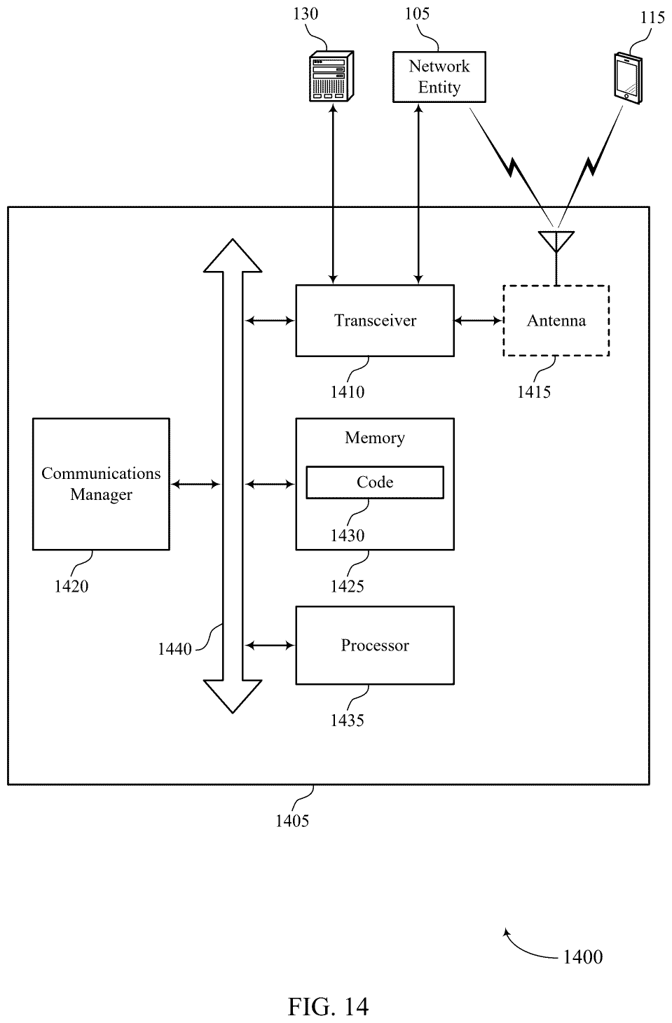

FIG. 14 shows a diagram of a system 1400 including a device 1405 that supports shared channel preparation time for multi-cell scheduling with different SCSs for scheduled cells in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting shared channel preparation time for multi-cell scheduling with different SCSs for scheduled cells). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting, via a third cell associated with a third cell subcarrier spacing, a message that schedules a first shared channel communication via a first cell associated with a first SCS and a second shared channel communication via a second cell associated with a second SCS, and where the first SCS is different than the second SCS. The communications manager 1420 is capable of, configured to, or operable to support a means for participating in the first shared channel communication via the first cell at least a time gap after output of the message where the time gap is based on the third cell SCS, the first SCS, and the second SCS. The communications manager 1420 is capable of, configured to, or operable to support a means for participating in the second shared channel communication via the second cell at least the time gap after output of the message. In some examples, the message may be a DCI message.

By including or configuring the communications manager 1420 in accordance with examples as described herein, the device 1405 may support techniques for improved communication reliability, reduced latency, more efficient utilization of communication resources, and improved coordination between devices.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of shared channel preparation time for multi-cell scheduling with different SCSs for scheduled cells as described herein, or the at least one processor 1435 and the at least one memory 1425 may be otherwise configured to, individually or collectively, perform or support such operations.

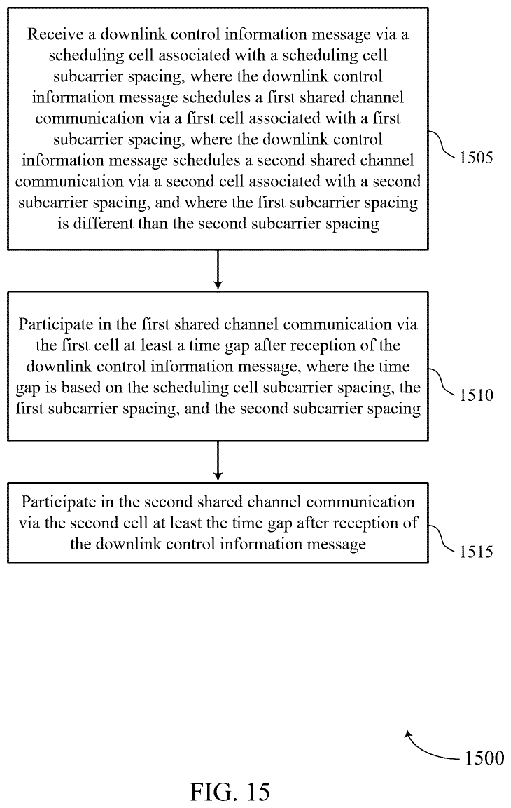

FIG. 15 shows a flowchart illustrating a method 1500 that supports shared channel preparation time for multi-cell scheduling with different SCSs for scheduled cells in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a DCI message via a scheduling cell associated with a scheduling cell SCS, where the DCI message schedules a first shared channel communication via a first cell associated with a first SCS, where the DCI message schedules a second shared channel communication via a second cell associated with a second SCS, and where the first SCS is different than the second SCS. The operations of 1505 may be performed in accordance with examples as disclosed herein. In some examples, aspects of the operations of 1505 may be performed by a DCI manager 925 as described with reference to FIG. 9.

At 1510, the method may include participating in the first shared channel communication via the first cell at least a time gap after reception of the DCI message, where the time gap is based on the scheduling cell SCS, the first SCS, and the second SCS. The operations of 1510 may be performed in accordance with examples as disclosed herein. In some examples, aspects of the operations of 1510 may be performed by a shared channel communication manager 930 as described with reference to FIG. 9.

At 1515, the method may include participating in the second shared channel communication via the second cell at least the time gap after reception of the DCI message. The operations of 1515 may be performed in accordance with examples as disclosed herein. In some examples, aspects of the operations of 1515 may be performed by a shared channel communication manager 930 as described with reference to FIG. 9.

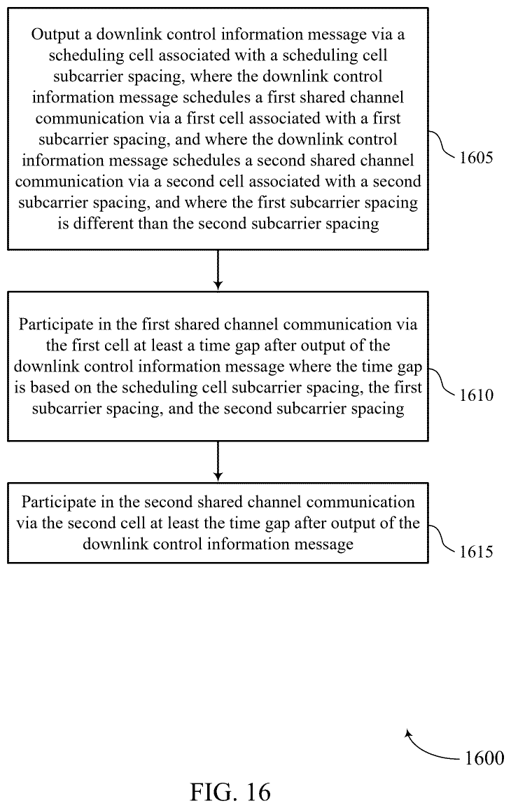

FIG. 16 shows a flowchart illustrating a method 1600 that supports shared channel preparation time for multi-cell scheduling with different SCSs for scheduled cells in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include outputting a DCI message via a scheduling cell associated with a scheduling cell SCS, where the DCI message schedules a first shared channel communication via a first cell associated with a first SCS, and where the DCI message schedules a second shared channel communication via a second cell associated with a second SCS, and where the first SCS is different than the second SCS. The operations of 1605 may be performed in accordance with examples as disclosed herein. In some examples, aspects of the operations of 1605 may be performed by a DCI manager 1325 as described with reference to FIG. 13.

At 1610, the method may include participating in the first shared channel communication via the first cell at least a time gap after output of the DCI message where the time gap is based on the scheduling cell SCS, the first SCS, and the second SCS. The operations of 1610 may be performed in accordance with examples as disclosed herein. In some examples, aspects of the operations of 1610 may be performed by a shared channel communication manager 1330 as described with reference to FIG. 13.

At 1615, the method may include participating in the second shared channel communication via the second cell at least the time gap after output of the DCI message. The operations of 1615 may be performed in accordance with examples as disclosed herein. In some examples, aspects of the operations of 1615 may be performed by 1335 as described with reference to FIG. 13.

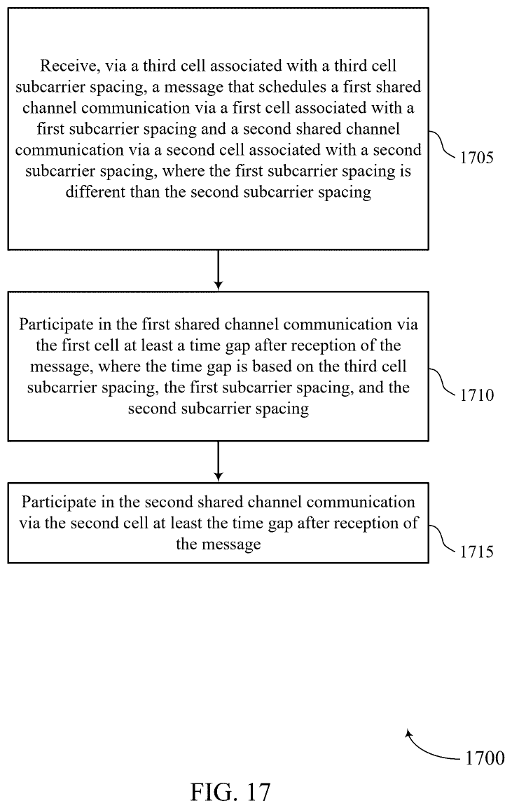

FIG. 17 shows a flowchart illustrating a method 1700 that supports shared channel preparation time for multi-cell scheduling with different SCSs for scheduled cells in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving, via a third cell associated with a third cell subcarrier spacing, a message that schedules a first shared channel communication via a first cell associated with a first SCS and a second shared channel communication via a second cell associated with a second SCS, where the first SCS is different than the second SCS. The operations of 1705 may be performed in accordance with examples as disclosed herein. In some examples, aspects of the operations of 1705 may be performed by a DCI manager 925 as described with reference to FIG. 9.

At 1710, the method may include participating in the first shared channel communication via the first cell at least a time gap after reception of the message, where the time gap is based on the third cell SCS, the first SCS, and the second SCS. The operations of 1710 may be performed in accordance with examples as disclosed herein. In some examples, aspects of the operations of 1710 may be performed by a shared channel communication manager 930 as described with reference to FIG. 9.

At 1715, the method may include participating in the second shared channel communication via the second cell at least the time gap after reception of the message. The operations of 1715 may be performed in accordance with examples as disclosed herein. In some examples, aspects of the operations of 1715 may be performed by a shared channel communication manager 930 as described with reference to FIG. 9.

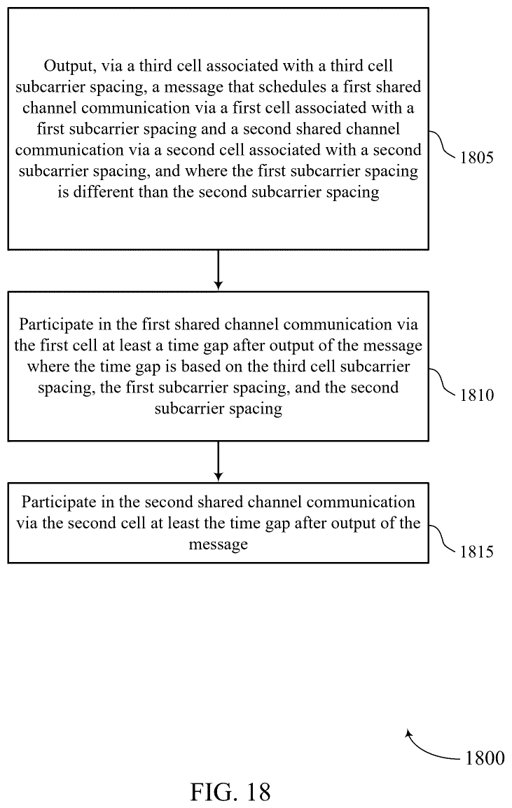

FIG. 18 shows a flowchart illustrating a method 1800 that supports shared channel preparation time for multi-cell scheduling with different SCSs for scheduled cells in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting, via a third cell associated with a third cell subcarrier spacing, a message that schedules a first shared channel communication via a first cell associated with a first SCS and a second shared channel communication via a second cell associated with a second SCS, where the first SCS is different than the second SCS. The operations of 1805 may be performed in accordance with examples as disclosed herein. In some examples, aspects of the operations of 1805 may be performed by a DCI manager 1325 as described with reference to FIG. 13.

At 1810, the method may include participating in the first shared channel communication via the first cell at least a time gap after output of the message where the time gap is based on the third cell SCS, the first SCS, and the second SCS. The operations of 1810 may be performed in accordance with examples as disclosed herein. In some examples, aspects of the operations of 1810 may be performed by a shared channel communication manager 1330 as described with reference to FIG. 13.

At 1815, the method may include participating in the second shared channel communication via the second cell at least the time gap after output of the message. The operations of 1815 may be performed in accordance with examples as disclosed herein. In some examples, aspects of the operations of 1815 may be performed by 1335 as described with reference to FIG. 13.

The following provides an overview of aspects of the present disclosure:

Aspect 1: A method for wireless communications at a UE, comprising: receiving, via a third cell associated with a third cell subcarrier spacing, a message that schedules a first shared channel communication via a first cell associated with a first SCS and a second shared channel communication via a second cell associated with a second SCS, wherein the first SCS is different than the second SCS; participating in the first shared channel communication via the first cell at least a time gap after reception of the DCI message, wherein the time gap is based at least in part on the third cell SCS, the first SCS, and the second SCS; and participating in the second shared channel communication via the second cell at least the time gap after reception of the DCI message.

Aspect 2: The method of aspect 1, wherein the time gap is based at least in part on a highest SCS from among a set of SCSs associated with a set of cells scheduled by the DCI message, wherein the set of cells includes the first cell and the second cell, and wherein the set of SCSs includes the first SCS and the second SCS.

Aspect 3: The method of aspect 1, wherein the time gap is based at least in part on a lowest SCS from among a set of SCSs associated with a set of cells scheduled by the DCI message, wherein the set of cells includes the first cell and the second cell, and wherein the set of SCSs includes the first SCS and the second SCS.

Aspect 4: The method of aspect 1, wherein the time gap is a largest time gap from a set of candidate time gaps, wherein the set of candidate time gaps are based at least in part on respective comparisons between the third cell SCS and a set of SCSs associated with a set of cells scheduled by the DCI message, the set of cells includes the first cell and the second cell, and wherein the set of SCSs includes the first SCS and the second SCS.

Aspect 5: The method of any of aspects 1 or 2, further comprising: receiving control signaling that indicates a set of cells schedulable by DCI in a search space monitored on the third cell, wherein the set of cells includes the first cell and the second cell, wherein the time gap is based at least in part on a highest SCS from among a set of SCSs associated with the set of cells, and wherein the set of SCSs includes the first SCS and the second SCS.

Aspect 6: The method of any of aspects 1 or 3, further comprising: receiving control signaling that indicates a set of cells schedulable by DCI in a search space monitored on the third cell, wherein the set of cells includes the first cell and the second cell, wherein the time gap is based at least in part on a lowest SCS from among a set of SCSs associated with the set of cells, and wherein the set of SCSs includes the first SCS and the second SCS.

Aspect 7: The method of any of aspects 1 or 4, further comprising: receiving control signaling that indicates a set of cells schedulable by DCI in a search space monitored on the third cell, wherein the set of cells includes the first cell and the second cell, wherein the time gap is a largest time gap from a set of candidate time gaps, wherein the set of candidate time gaps are based at least in part on respective comparisons between the third cell SCS and a set of SCSs associated with the set of cells, and wherein the set of SCSs includes the first SCS and the second SCS.

Aspect 8: The method of any of aspects 1 through 7, further comprising: participating in a third shared channel communication via a third cell associated with a third SCS at least the time gap after reception of the DCI message, wherein the DCI message schedules the third shared channel communication via the third cell, wherein the time gap is based at least in part on the third SCS.

Aspect 9: The method of any of aspects 1 through 8, wherein at least one of the first SCS or the second SCS is a same as the third cell SCS.

Aspect 10: The method of any of aspects 1 through 9, further comprising: receiving control signaling that indicates a set of cells schedulable by DCI in a search space monitored on the third cell, wherein the set of cells includes the first cell and the second cell, refraining from monitoring for respective downlink shared channel transmissions via the set of cells during the time gap; and monitoring for the respective downlink shared channel transmissions via the set of cells after the time gap, wherein participation in the first shared channel communication or the second shared channel communication is based at least on the monitoring.

Aspect 11: A method for wireless communications at a network entity, comprising: outputting, via a third cell associated with a third cell subcarrier spacing, a message that schedules a first shared channel communication via a first cell associated with a first SCS and a second shared channel communication via a second cell associated with a second SCS, wherein the first SCS is different than the second SCS; participating in the first shared channel communication via the first cell at least a time gap after output of the DCI message wherein the time gap is based at least in part on the third cell SCS, the first SCS, and the second SCS; and participating in the second shared channel communication via the second cell at least the time gap after output of the DCI message.

Aspect 12: The method of aspect 11, wherein the time gap is based at least in part on a highest SCS from among a set of SCSs associated with a set of cells scheduled by the DCI message, wherein the set of cells includes the first cell and the second cell, and wherein the set of SCSs includes the first SCS and the second SCS.

Aspect 13: The method of aspect 11, wherein the time gap is based at least in part on a lowest SCS from among a set of SCSs associated with a set of cells scheduled by the DCI message, wherein the set of cells includes the first cell and the second cell, and wherein the set of SCSs includes the first SCS and the second SCS.

Aspect 14: The method of aspect 11, wherein the time gap is a largest time gap from a set of candidate time gaps, wherein the set of candidate time gaps are based at least in part on respective comparisons between the third cell SCS and a set of SCSs associated with a set of cells scheduled by the DCI message, wherein the set of cells includes the first cell and the second cell, and wherein the set of SCSs includes the first SCS and the second SCS.

Aspect 15: The method of any of aspects 11 or 12, further comprising: outputting control signaling that indicates a set of cells schedulable by DCI in a search space configured for the third cell, wherein the set of cells includes the first cell and the second cell, wherein the time gap is based at least in part on a highest SCS from among a set of SCSs associated with the set of cells, and wherein the set of SCSs includes the first SCS and the second SCS.

Aspect 16: The method of any of aspects 11 or 13, further comprising: outputting control signaling that indicates a set of cells schedulable by DCI in a search space configured for the third cell, wherein the set of cells includes the first cell and the second cell, wherein the time gap is based at least in part on a lowest SCS from among a set of SCSs associated with the set of cells, and wherein the set of SCSs includes the first SCS and the second SCS.

Aspect 17: The method of any of aspects 11 or 14, further comprising: outputting control signaling that indicates a set of cells schedulable by DCI in a search space configured for the third cell, wherein the set of cells includes the first cell and the second cell, wherein the time gap is a largest time gap from a set of candidate time gaps, wherein the set of candidate time gaps are based at least in part on respective comparisons between the third cell SCS and a set of SCSs associated with the set of cells, and wherein the set of SCSs includes the first SCS and the second SCS.

Aspect 18: The method of any of aspects 11 through 17, further comprising: participating in a third shared channel communication via a third cell associated with a third SCS at least the time gap after output of the DCI message, wherein the DCI message schedules the third shared channel communication via the third cell, wherein the time gap is based at least in part on the third SCS.

Aspect 19: The method of any of aspects 11 through 18, wherein at least one of the first SCS or the second SCS is a same as the third cell SCS.

Aspect 20: An apparatus for wireless communications at a UE, one or more memories; and one or more processors coupled with the one or more memories and configured to cause the UE to perform a method of any of aspects 1 through 10.

Aspect 21: A UE for wireless communications, comprising at least one means for performing a method of any of aspects 1 through 10.

Aspect 22: A non-transitory computer-readable medium storing code for wireless communications, the code comprising instructions executable by one or more processors to perform a method of any of aspects 1 through 10.

Aspect 23: An apparatus for wireless communications at a network entity, one or more memories; and one or more processors coupled with the one or more memories and configured to cause the network entity to perform a method of any of aspects 11 through 19.

Aspect 24: A network entity for wireless communications, comprising at least one means for performing a method of any of aspects 11 through 19.

Aspect 25: A non-transitory computer-readable medium storing code for wireless communications, the code comprising instructions executable by one or more processors to perform a method of any of aspects 11 through 19.

The following provides another overview of aspects of the present disclosure:

Aspect 1: A method for wireless communications at a UE, comprising: receiving a DCI message via a scheduling cell associated with a scheduling cell SCS, wherein the DCI message schedules a first shared channel communication via a first cell associated with a first SCS, wherein the DCI message schedules a second shared channel communication via a second cell associated with a second SCS, and wherein the first SCS is different than the second SCS; participating in the first shared channel communication via the first cell at least a time gap after reception of the DCI message, wherein the time gap is based at least in part on the scheduling cell SCS, the first SCS, and the second SCS; and participating in the second shared channel communication via the second cell at least the time gap after reception of the DCI message.

Aspect 2: The method of aspect 1, wherein the time gap is based at least in part on a highest SCS from among a set of SCSs associated with a set of cells scheduled by the DCI message, wherein the set of cells includes the first cell and the second cell, and wherein the set of SCSs includes the first SCS and the second SCS.

Aspect 3: The method of aspect 1, wherein the time gap is based at least in part on a lowest SCS from among a set of SCSs associated with a set of cells scheduled by the DCI message, wherein the set of cells includes the first cell and the second cell, and wherein the set of SCSs includes the first SCS and the second SCS.

Aspect 4: The method of aspect 1, wherein the time gap is a largest time gap from a set of candidate time gaps, wherein the set of candidate time gaps are based at least in part on respective comparisons between the scheduling cell SCS and a set of SCSs associated with a set of cells scheduled by the DCI message, the set of cells includes the first cell and the second cell, and wherein the set of SCSs includes the first SCS and the second SCS.

Aspect 5: The method of any of aspects 1 or 2, further comprising: receiving control signaling that indicates a set of cells schedulable by DCI in a search space monitored on the scheduling cell, wherein the set of cells includes the first cell and the second cell, wherein the time gap is based at least in part on a highest SCS from among a set of SCSs associated with the set of cells, and wherein the set of SCSs includes the first SCS and the second SCS.

Aspect 6: The method of any of aspects 1 or 3, further comprising: receiving control signaling that indicates a set of cells schedulable by DCI in a search space monitored on the scheduling cell, wherein the set of cells includes the first cell and the second cell, wherein the time gap is based at least in part on a lowest SCS from among a set of SCSs associated with the set of cells, and wherein the set of SCSs includes the first SCS and the second SCS.

Aspect 7: The method of any of aspects 1 or 4, further comprising: receiving control signaling that indicates a set of cells schedulable by DCI in a search space monitored on the scheduling cell, wherein the set of cells includes the first cell and the second cell, wherein the time gap is a largest time gap from a set of candidate time gaps, wherein the set of candidate time gaps are based at least in part on respective comparisons between the scheduling cell SCS and a set of SCSs associated with the set of cells, and wherein the set of SCSs includes the first SCS and the second SCS.

Aspect 8: The method of any of aspects 1 through 7, further comprising: participating in a third shared channel communication via a third cell associated with a third SCS at least the time gap after reception of the DCI message, wherein the DCI message schedules the third shared channel communication via the third cell, wherein the time gap is based at least in part on the third SCS.

Aspect 9: The method of any of aspects 1 through 8, wherein at least one of the first SCS or the second SCS is a same as the scheduling cell SCS.

Aspect 10: The method of any of aspects 1 through 9, further comprising: receiving control signaling that indicates a set of cells schedulable by DCI in a search space monitored on the scheduling cell, wherein the set of cells includes the first cell and the second cell, refraining from monitoring for respective downlink shared channel transmissions via the set of cells during the time gap; and monitoring for the respective downlink shared channel transmissions via the set of cells after the time gap, wherein participation in the first shared channel communication or the second shared channel communication is based at least on the monitoring.

Aspect 11: A method for wireless communications at a network entity, comprising: outputting a DCI message via a scheduling cell associated with a scheduling cell SCS, wherein the DCI message schedules a first shared channel communication via a first cell associated with a first SCS, and wherein the DCI message schedules a second shared channel communication via a second cell associated with a second SCS, and wherein the first SCS is different than the second SCS; participating in the first shared channel communication via the first cell at least a time gap after output of the DCI message wherein the time gap is based at least in part on the scheduling cell SCS, the first SCS, and the second SCS; and participating in the second shared channel communication via the second cell at least the time gap after output of the DCI message.

Aspect 12: The method of aspect 11, wherein the time gap is based at least in part on a highest SCS from among a set of SCSs associated with a set of cells scheduled by the DCI message, wherein the set of cells includes the first cell and the second cell, and wherein the set of SCSs includes the first SCS and the second SCS.

Aspect 13: The method of aspect 11, wherein the time gap is based at least in part on a lowest SCS from among a set of SCSs associated with a set of cells scheduled by the DCI message, wherein the set of cells includes the first cell and the second cell, and wherein the set of SCSs includes the first SCS and the second SCS.

Aspect 14: The method of aspect 11, wherein the time gap is a largest time gap from a set of candidate time gaps, wherein the set of candidate time gaps are based at least in part on respective comparisons between the scheduling cell SCS and a set of SCSs associated with a set of cells scheduled by the DCI message, wherein the set of cells includes the first cell and the second cell, and wherein the set of SCSs includes the first SCS and the second SCS.

Aspect 15: The method of any of aspects 11 or 12, further comprising: outputting control signaling that indicates a set of cells schedulable by DCI in a search space configured for the scheduling cell, wherein the set of cells includes the first cell and the second cell, wherein the time gap is based at least in part on a highest SCS from among a set of SCSs associated with the set of cells, and wherein the set of SCSs includes the first SCS and the second SCS.

Aspect 16: The method of any of aspects 11 or 13, further comprising: outputting control signaling that indicates a set of cells schedulable by DCI in a search space configured for the scheduling cell, wherein the set of cells includes the first cell and the second cell, wherein the time gap is based at least in part on a lowest SCS from among a set of SCSs associated with the set of cells, and wherein the set of SCSs includes the first SCS and the second SCS.

Aspect 17: The method of any of aspects 11 or 14, further comprising: outputting control signaling that indicates a set of cells schedulable by DCI in a search space configured for the scheduling cell, wherein the set of cells includes the first cell and the second cell, wherein the time gap is a largest time gap from a set of candidate time gaps, wherein the set of candidate time gaps are based at least in part on respective comparisons between the scheduling cell SCS and a set of SCSs associated with the set of cells, and wherein the set of SCSs includes the first SCS and the second SCS.

Aspect 18: The method of any of aspects 11 through 17, further comprising: participating in a third shared channel communication via a third cell associated with a third SCS at least the time gap after output of the DCI message, wherein the DCI message schedules the third shared channel communication via the third cell, wherein the time gap is based at least in part on the third SCS.

Aspect 19: The method of any of aspects 11 through 18, wherein at least one of the first SCS or the second SCS is a same as the scheduling cell SCS.

Aspect 20: An apparatus for wireless communications at a UE, one or more memories; and one or more processors coupled with the one or more memories and configured to cause the UE to perform a method of any of aspects 1 through 10.

Aspect 21: A UE for wireless communications, comprising at least one means for performing a method of any of aspects 1 through 10.

Aspect 22: A non-transitory computer-readable medium storing code for wireless communications, the code comprising instructions executable by one or more processors to perform a method of any of aspects 1 through 10.

Aspect 23: An apparatus for wireless communications at a network entity, one or more memories; and one or more processors coupled with the one or more memories and configured to cause the network entity to perform a method of any of aspects 11 through 19.

Aspect 24: A network entity for wireless communications, comprising at least one means for performing a method of any of aspects 11 through 19.

Aspect 25: A non-transitory computer-readable medium storing code for wireless communications, the code comprising instructions executable by one or more processors to perform a method of any of aspects 11 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.” Additionally, a “set” refers to one or more items unless specifically disclosed differently (e.g., a set of a plurality of items), and a “subset” refers to a non-empty portion that is less than a whole set unless specifically disclosed to the differently (e.g., a subset of zero or more items of the set one or more items).

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
receive, via a third cell associated with a third cell subcarrier spacing, a message that schedules a first shared channel communication via a first cell associated with a first subcarrier spacing and a second shared channel communication via a second cell associated with a second subcarrier spacing, wherein the first subcarrier spacing is different than the second subcarrier spacing;
participate in the first shared channel communication via the first cell at least a time gap after reception of the message, wherein the time gap is based at least in part on the third cell subcarrier spacing, the first subcarrier spacing, and the second subcarrier spacing; and
participate in the second shared channel communication via the second cell at least the time gap after reception of the message.

2. The apparatus of claim 1, wherein:
the time gap is based at least in part on a lowest subcarrier spacing from among a set of subcarrier spacings associated with a set of cells scheduled by the message,
the set of cells includes the first cell and the second cell, and
the set of subcarrier spacings includes the first subcarrier spacing and the second subcarrier spacing.

3. The apparatus of claim 1, wherein:
the time gap is a largest time gap from a set of candidate time gaps,
the set of candidate time gaps are based at least in part on respective comparisons between the third cell subcarrier spacing and a set of subcarrier spacings associated with a set of cells scheduled by the message,
the set of cells includes the first cell and the second cell, and
the set of subcarrier spacings includes the first subcarrier spacing and the second subcarrier spacing.

4. The apparatus of claim 1, wherein the one or more processors are configured to cause the UE to:
receive control signaling that indicates a set of cells schedulable by downlink control information in a search space monitored on the third cell, wherein the set of cells includes the first cell and the second cell, wherein the time gap is based at least in part on a lowest subcarrier spacing from among a set of subcarrier spacings associated with the set of cells, and wherein the set of subcarrier spacings includes the first subcarrier spacing and the second subcarrier spacing.

5. The apparatus of claim 1, wherein the one or more processors are configured to cause the UE to:
receive control signaling that indicates a set of cells schedulable by downlink control information in a search space monitored on the third cell, wherein the set of cells includes the first cell and the second cell, wherein the time gap is a largest time gap from a set of candidate time gaps, wherein the set of candidate time gaps are based at least in part on respective comparisons between the third cell subcarrier spacing and a set of subcarrier spacings associated with the set of cells, and wherein the set of subcarrier spacings includes the first subcarrier spacing and the second subcarrier spacing.

6. The apparatus of claim 1, wherein:
the time gap is based at least in part on a highest subcarrier spacing from among a set of subcarrier spacings associated with a set of cells scheduled by the message,
the set of cells includes the first cell and the second cell, and
the set of subcarrier spacings includes the first subcarrier spacing and the second subcarrier spacing.

7. The apparatus of claim 1, wherein the one or more processors are configured to cause the UE to:
receive control signaling that indicates a set of cells schedulable by downlink control information in a search space monitored on the third cell, wherein the set of cells includes the first cell and the second cell, wherein the time gap is based at least in part on a highest subcarrier spacing from among a set of subcarrier spacings associated with the set of cells, and wherein the set of subcarrier spacings includes the first subcarrier spacing and the second subcarrier spacing.

8. The apparatus of claim 1, wherein the one or more processors are configured to cause the UE to:
participate in a third shared channel communication via a third cell associated with a third subcarrier spacing at least the time gap after reception of the message, wherein the message schedules the third shared channel communication via the third cell, wherein the time gap is based at least in part on the third subcarrier spacing.

9. The apparatus of claim 1, wherein at least one of the first subcarrier spacing or the second subcarrier spacing is a same as the third cell subcarrier spacing.

10. The apparatus of claim 1, wherein the one or more processors are configured to cause the UE to:
receive control signaling that indicates a set of cells schedulable by downlink control information in a search space monitored on the third cell, wherein the set of cells includes the first cell and the second cell,
refrain from monitoring for respective downlink shared channel transmissions via the set of cells during the time gap; and
monitor for the respective downlink shared channel transmissions via the set of cells after the time gap, wherein participation in the first shared channel communication or the second shared channel communication is based at least on the one or more processors configured to cause the UE to monitor for the respective downlink shared channel transmissions via the set of cells after the time gap.

11. An apparatus for wireless communication at a network entity, comprising:
one or more memories; and
one or more processors coupled with the one or more memories and configured to cause the network entity to:
output, via a third cell associated with a third cell subcarrier spacing, a message that schedules a first shared channel communication via a first cell associated with a first subcarrier spacing and a second shared channel communication via a second cell associated with a second subcarrier spacing, wherein the first subcarrier spacing is different than the second subcarrier spacing;
participate in the first shared channel communication via the first cell at least a time gap after output of the message wherein the time gap is based at least in part on the third cell subcarrier spacing, the first subcarrier spacing, and the second subcarrier spacing; and
participate in the second shared channel communication via the second cell at least the time gap after output of the message.

12. The apparatus of claim 11, wherein:
the time gap is based at least in part on a lowest subcarrier spacing from among a set of subcarrier spacings associated with a set of cells scheduled by the message,
the set of cells includes the first cell and the second cell, and
the set of subcarrier spacings includes the first subcarrier spacing and the second subcarrier spacing.

13. The apparatus of claim 11, wherein:
the time gap is a largest time gap from a set of candidate time gaps,
the set of candidate time gaps are based at least in part on respective comparisons between the third cell subcarrier spacing and a set of subcarrier spacings associated with a set of cells scheduled by the message,
the set of cells includes the first cell and the second cell, and
the set of subcarrier spacings includes the first subcarrier spacing and the second subcarrier spacing.

14. The apparatus of claim 11, wherein the one or more processors are configured to cause the network entity to:
output control signaling that indicates a set of cells schedulable by downlink control information in a search space configured for the third cell, wherein the set of cells includes the first cell and the second cell, wherein the time gap is based at least in part on a lowest subcarrier spacing from among a set of subcarrier spacings associated with the set of cells, and wherein the set of subcarrier spacings includes the first subcarrier spacing and the second subcarrier spacing.

15. The apparatus of claim 11, wherein the one or more processors are configured to cause the network entity to:
output control signaling that indicates a set of cells schedulable by downlink control information in a search space configured for the third cell, wherein the set of cells includes the first cell and the second cell, wherein the time gap is a largest time gap from a set of candidate time gaps, wherein the set of candidate time gaps are based at least in part on respective comparisons between the third cell subcarrier spacing and a set of subcarrier spacings associated with the set of cells, and wherein the set of subcarrier spacings includes the first subcarrier spacing and the second subcarrier spacing.

16. The apparatus of claim 11, wherein:
the time gap is based at least in part on a highest subcarrier spacing from among a set of subcarrier spacings associated with a set of cells scheduled by the message,
the set of cells includes the first cell and the second cell, and
the set of subcarrier spacings includes the first subcarrier spacing and the second subcarrier spacing.

17. The apparatus of claim 11, wherein the one or more processors are configured to cause the network entity to:
output control signaling that indicates a set of cells schedulable by downlink control information in a search space configured for the third cell, wherein the set of cells includes the first cell and the second cell, wherein the time gap is based at least in part on a highest subcarrier spacing from among a set of subcarrier spacings associated with the set of cells, and wherein the set of subcarrier spacings includes the first subcarrier spacing and the second subcarrier spacing.

18. The apparatus of claim 11, wherein the one or more processors are configured to cause the network entity to:
participate in a third shared channel communication via a third cell associated with a third subcarrier spacing at least the time gap after output of the message, wherein the message schedules the third shared channel communication via the third cell, wherein the time gap is based at least in part on the third subcarrier spacing.

19. The apparatus of claim 11, wherein at least one of the first subcarrier spacing or the second subcarrier spacing is a same as the third cell subcarrier spacing.

20. A method for wireless communications at a user equipment (UE), comprising:
receiving, via a third cell associated with a third cell subcarrier spacing, a message that schedules a first shared channel communication via a first cell associated with a first subcarrier spacing and a second shared channel communication via a second cell associated with a second subcarrier spacing, wherein the first subcarrier spacing is different than the second subcarrier spacing;
participating in the first shared channel communication via the first cell at least a time gap after reception of the message, wherein the time gap is based at least in part on the third cell subcarrier spacing, the first subcarrier spacing, and the second subcarrier spacing; and
participating in the second shared channel communication via the second cell at least the time gap after reception of the message.
